(19) United States
(12) Patent Application Publication
(10) Pub. No.: US 2025/0238500 A1
(43) Pub. Date: Jul. 24, 2025

(54) VEHICLE SECURITY SYSTEM AND SECURITY METHOD

(71) Applicant: Panasonic Automotive Systems Co., Ltd., Kanagawa (JP)

(72) Inventors: Takumaru NAGAI, Osaka (JP); Kaoru YOKOTA, Hyogo (JP); Tomohisa SEZAKI, Kanagawa (JP); Akihito TAKEUCHI, Osaka (JP); Yoshiharu IMAMOTO, Kanagawa (JP); Ryo HIRANO, Kanagawa (JP)

(73) Assignee: Panasonic Automotive Systems Co., Ltd., Kanagawa (JP)

(21) Appl. No.: 19/013,746

(22) Filed: Jan. 8, 2025

(30) Foreign Application Priority Data
Jan. 19, 2024 (JP) 2024-006620
Apr. 2, 2024 (JP) 2024-059616

(51) Int. Cl. G06F 21/53; G06F 8/65; G06F 21/57

(52) U.S. Cl. CPC G06F 21/53; G06F 8/65; G06F 21/577

(57) ABSTRACT

Vehicle security system includes a plurality of groups into which a plurality of software areas are separated for each virtual machine or each container, and includes first communication controller, second communication controller, and third communication controller. First communication controller manages communication related to a software area belonging to a first group of the plurality of groups. Second communication controller manages communication related to the software area belonging to a second group of the plurality of groups. Third communication controller manages communication between the software area belonging to the first group and the software area belonging to the second group, separately from the first communication and the second communication.

### CROSS REFERENCE TO RELATED APPLICATIONS

The present application is based on and claims priority of Japanese Patent Application No. 2024-006620 filed on Jan. 19, 2024, and Japanese Patent Application No. 2024-059616 filed on Apr. 2, 2024.

### FIELD

The present disclosure relates to a vehicle security system in a vehicle, and the like.

### BACKGROUND

With the evolution of in-vehicle architecture, a technology that uses virtualization technology to integrate the functions of a plurality of electronic control units (ECUs) into a single ECU is known. In addition, an increasing number of vehicles allow users to update their software even after purchasing the vehicle, such as paid upgrades in a software defined vehicle (SDV) or the incorporation of third-party applications. In this way, while user convenience is improved, the importance of security measures such as defense against or response to attacks from malicious software is also increasing.

In light of this background, a security system is being considered that separates the safety area, which includes functions related to the vehicle's safety (functions such as travelling, turning, stopping, or the like), from the external connection area (EP: Entry Point), which includes external connection functions that could serve as an entry point for attackers, in the dynamically updated software environment of a vehicle, so that even if an attacker is allowed to infiltrate the EP, the damage should not extend to functions related to the safety of the vehicle.

For example, Patent Literature (PTL) 1 discloses a technology that provides hierarchical virtualization using a hypervisor. In addition, PTL 2 discloses a technology that dynamically changes the partition configuration of a computer system.

### CITATION LIST

### Patent Literature

PTL 1: Japanese Unexamined Patent Application Publication (Translation of PCT Application) No. 2009-506462
PTL 2: Japanese Patent No. 4199444

### SUMMARY

However, the techniques disclosed in PTL 1 and PTL 2 can be improved upon.

Therefore, the present disclosure provides a vehicle security system and the like capable of improving upon the above related arts.

A vehicle security system according to one aspect of the present disclosure is a vehicle security system in a vehicle. The vehicle security system includes a plurality of groups into which a plurality of software areas are separated for each virtual machine or each container, and includes a first communication controller, a second communication controller, and a third communication controller. The first communication controller manages first communication related to a software area belonging to a first group of the plurality of groups. The second communication controller manages second communication related to a software area belonging to a second group of the plurality of groups. The third communication controller manages communication between the software area belonging to the first group and the software area belonging to the second group, separately from the first communication and the second communication.

A security method according to one aspect of the present disclosure is a security method executed by a vehicle security system in a vehicle. The vehicle security system includes a plurality of groups into which a plurality of software areas are separated for each virtual machine or each container. The security method manages communication related to a software area belonging to a first group of the plurality of groups. The security method manages communication related to a software area belonging to a second group of the plurality of groups. The security method manages communication between the software area belonging to the first group and the software area belonging to the second group.

According to one aspect of the present disclosure, the techniques disclosed in PTL 1 and PTL 2 can be further improved upon.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing an example of the functional configuration of a vehicle security system according to an embodiment.

FIG. 2 is a block diagram showing Communication Example 1 of the vehicle security system according to the embodiment.

FIG. 3 is a sequence diagram showing Communication Example 1 of the vehicle security system according to the embodiment.

FIG. 4 is a block diagram showing Communication Example 2 of the vehicle security system according to the embodiment.

FIG. 5 is a sequence diagram showing Communication Example 2 of the vehicle security system relating to the embodiment.

FIG. 6 is a block diagram showing Communication Example 3 of the vehicle security system according to the embodiment.

FIG. 7 is a sequence diagram showing Communication Example 3 of the vehicle security system relating to the embodiment.

FIG. 8 is a block diagram showing Communication Example 4 of the vehicle security system according to the embodiment.

FIG. 9 is a sequence diagram showing Communication Example 4 of the vehicle security system according to the embodiment.

FIG. 10 is a block diagram showing Communication Example 5 of the vehicle security system according to the embodiment.

FIG. 11 is a sequence diagram showing Communication Example 5 of the vehicle security system according to the embodiment.

FIG. 12 is a block diagram showing Communication Example 6 of the vehicle security system according to the embodiment.

FIG. 13 is a sequence diagram showing Communication Example 6 of the vehicle security system according to the embodiment.

FIG. 14 is a block diagram showing Communication Example 7 of the vehicle security system according to the embodiment.

FIG. 15 is a sequence diagram showing Communication Example 7 of the vehicle security system according to the embodiment.

FIG. 16 is a block diagram showing Communication Example 8 of the vehicle security system according to the embodiment.

FIG. 17 is a sequence diagram showing Communication Example 8 of the vehicle security system according to the embodiment.

FIG. 18 is a block diagram showing Communication Example 9 of the vehicle security system according to the embodiment.

FIG. 19 is a sequence diagram showing Communication Example 9 of the vehicle security system according to the embodiment.

FIG. 20 is a block diagram showing Communication Example 10 of the vehicle security system according to the embodiment.

FIG. 21 is a sequence diagram showing Communication Example 10 of the vehicle security system according to the embodiment.

FIG. 22 is a block diagram showing Communication Example 11 of the vehicle security system according to the embodiment.

FIG. 23A is a sequence diagram showing Communication Example 11 of the vehicle security system according to the embodiment.

FIG. 23B is a sequence diagram showing Communication Example 11 of the vehicle security system according to the embodiment.

FIG. 24 is a block diagram showing Communication Example 12 of the vehicle security system according to the embodiment.

FIG. 25A is a sequence diagram showing Communication Example 12 of the vehicle security system according to the embodiment.

FIG. 25B is a sequence diagram showing Communication Example 12 of the vehicle security system according to the embodiment.

### DESCRIPTION OF EMBODIMENT

### (Underlying Knowledge Forming Basis of the Present Disclosure)

The inventors of the present disclosure found that the techniques described in “Background” section have problems as described below.

The evolution of in-vehicle architecture is moving toward further integration of functions into a single ECU called a high performance computer (HPC), but it is currently in a transitional period of integration. For this reason, some in-vehicle systems contain a mixture of conventional ECUs and domain controllers (DCs), which are ECUs in which only some of the functions are integrated. Even in in-vehicle systems in which such a plurality of ECUs (including DCs) are present and software is dynamically updated, separating the external connection region from the safety region, in other words, the separation of partitions is necessary.

However, the technology disclosed in PTL 1 is a technology on a single virtual machine (on the same hypervisor), and there is a problem that it cannot support separation of partitions across a plurality of virtual machines.

In addition, although the technology disclosed in PTL 2 is a technology for separating and reconfiguring partitions across a plurality of machines (CPU boards), it is a method for centrally managing all resources using a management node, so that there is a problem that operating costs tend to be high in complex in-vehicle systems including a plurality of virtual machines.

The following describes an embodiment in detail with reference to the drawings.

It should be noted that each of the embodiments described below shows comprehensive or specific example. The numerical values, shapes, materials, components, arrangement positions and connection forms of the components, and the like shown in the following embodiments are merely examples and are not intended to limit the present disclosure.

### Embodiment

Hereinafter, a vehicle security system according to an embodiment will be described.

### 1. Configuration of Vehicle Security System

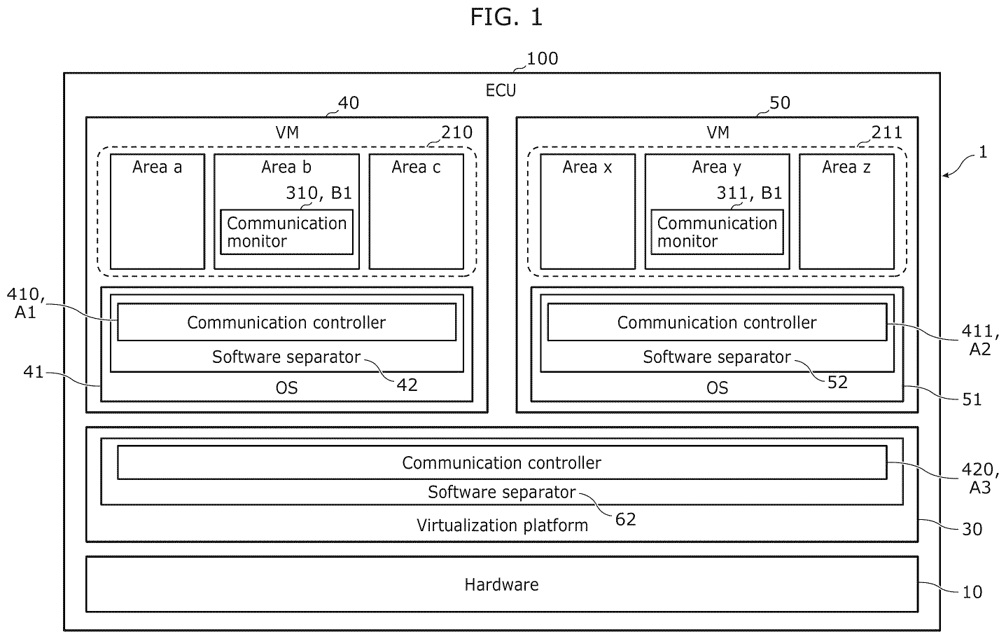

FIG. 1 is a block diagram showing an example of the functional configuration of vehicle security system 1 according to an embodiment. Vehicle security system 1 is in a vehicle (an example of a moving body). Vehicle security system 1 is a system that controls communication for each of a plurality of groups into which a plurality of software areas are divided for each virtual machine or each device such as ECU. The plurality of groups include, for example, a group including one or more untrusted areas and a group including one or more trusted areas.

The untrusted area is an external connection area that includes, for example, an entry point (EP), a communication function with the outside, a transport level security (TLS) termination, or the like, and has external connection functions that can serve as an entry point for attackers. The trusted area is a safety area that includes, for example, functions related to the safety of the vehicle (functions such as travelling, turning, and stopping).

In addition, vehicle security system 1 is a system that controls communication for each of a plurality of partitions that are obtained by logically dividing a plurality of software areas. It should be noted that partitions are divisions that are different from groups, which will be described later. A partition may be composed of one or more software areas in one ECU. In addition, a plurality of software areas in one ECU may be divided into a plurality of partitions. In addition, a partition may be composed to span a plurality of ECUs. For example, when a first ECU and a second ECU exist in a vehicle, one partition may be composed of the software area of the first ECU and the software area of the second ECU.

Vehicle security system 1 allows access to internal information within the same partition, while prohibiting or restricting access to the internal information from other partitions. In addition, when communication is performed from any partition to another partition, vehicle security system 1 monitors the communication. In the embodiment, vehicle security system 1 is in integrated ECU 100 provided in the vehicle, and includes first communication controller A1, second communication controller A2, third communication controller A3, and communication monitor B1. It is sufficient for vehicle security system 1 to include these components, and the configuration of integrated ECU 100 provided in the vehicle excluding these components does not need to be a component of vehicle security system 1.

Integrated ECU 100 is a central ECU that integrates a plurality of ECUs. Integrated ECU 100 is an ECU that integrates functions that were previously separated into a plurality of ECUs in order to solve problems of increasing development time and costs that accompany the increasing complexity of in-vehicle systems, and is an ECU that utilizes virtualization technology to operate a plurality of virtual computers (virtual machines: VMs) on a single ECU. Integrated ECU 100 is a computer that includes a processor (microprocessor), a memory, and the like. The memory is a read only memory (ROM), a random access memory (RAM), and the like, and can store programs executed by the processor.

Integrated ECU 100 includes hardware 10 configured as a system on chip (SoC), and virtualization platform 30 runs on hardware 10. On virtualization platform 30, one or more virtual machines (here, virtual machines 40, 50) that are separated from each other are running, and one or more different operating systems (OSs) (here, OSs 41, 51) run on the one or more virtual machines, respectively.

Hardware 10 is a machine or device that can accept data, perform logical operations on the data, store the data in memory, and display the data on a display or the like. Hardware 10 may include a processor and a memory. Hardware 10 includes a communication interface for communicating with other hardware in the vehicle via, for example, Ethernet, controller area network (CAN), serial peripheral interface (SPI), or the like.

Virtualization platform 30 is, for example, a hypervisor or the like, and is software that serves as a virtualization infrastructure for running one or more virtual machines (here, virtual machines 40, 50). Virtualization platform 30 includes software separator 62 that separates the one or more virtual machines. In addition, software separator 62 includes communication controller 420. Communication controller 420 controls communication with one of machines 40 and 50 as the sender, and communication with one of virtual machines 40 and 50 as the destination. That is, communication with virtual machines 40 and 50 is possible only via communication controller 420.

Virtual machine 40 includes OS 41 and one or more software areas. OS 41 includes software separator 42 that separates the one or more software areas by container technology or the like. Here, virtual machine 40 is separated by software separator 42 into three software areas (containers): “area a”, “area b”, and “area c”. “Area a” is, for example, an untrusted area, and “area c” is, for example, a trusted area. In addition, “area b” is, for example, an intermediate area passed through when communicating between the trusted area and other areas, and includes communication monitor 310 that monitors communication to functions belonging to the trusted area “area c”.

In addition, software separator 42 includes communication controller 410. Communication controller 410 controls communication with one of the one or more software areas of virtual machine 40 as the sender, and communication with one of the one or more software areas of virtual machine 40 as the destination. That is, communication with the one or more software areas of virtual machine 40 is possible only via communication controller 410.

Virtual machine 50 includes OS 51 and one or more software areas. OS 51 includes software separator 52 that separates the one or more software areas by container technology or the like. Here, virtual machine 50 is separated by software separator 52 into three software areas (containers): “area x”, “area y”, and “area z”. “Area x” is, for example, an untrusted area, and “area z” is, for example, a trusted area. In addition, “area y” is, for example, an intermediate area passed through when communicating between the trusted area and other areas, and includes communication monitor 311 that monitors communication to functions belonging to the trusted area “area z”.

In addition, software separator 52 includes communication controller 411. Communication controller 411 controls communication with one of the one or more software areas of virtual machine 50 as the sender, and communication with one of the one or more software areas of virtual machine 50 as the destination. That is, communication with the one or more software areas of virtual machine 50 is possible only via communication controller 411.

Here, the three software areas of virtual machine 40 and the three software areas of virtual machine 50, a total of six software areas, are divided into two groups 210 and 211 for the respective virtual machines. In the example shown in FIG. 1, “area a”, “area b”, and “area c” of virtual machine 40 belong to group 210, and “area x”, “area y”, and “area z” of virtual machine 50 belong to group 211.

In the embodiment, group 210 (first group) includes, as software areas, “area a” (first area), “area b” (second area), and “area c” (third area) according to a degree of trustworthiness. Here, the degree of trustworthiness represents the degree of possibility of being tampered by an attacker, and the higher the degree of trustworthiness, the lower the possibility of being tampered by an attacker, and the lower the degree of trustworthiness, the higher the possibility of being tampered by an attacker. In group 210, “area a” (first area) is an untrusted area, and the degree of trustworthiness thereof is lower than those of “area b” (second area) and “area c” (third area). In addition, “area c” (third area) is a trusted area, and has the degree of trustworthiness thereof is higher than those of “area a” (first area) and “area b” (second area). In addition, “area b” (second area) is an intermediate area, and includes communication monitor 310 that monitors communication to “area c” (third area). In other words, group 210 (first group) includes “area b” (software area) that includes communication monitor 310 as a software area.

In addition, in the embodiment, group 211 (second group) includes, as software areas, “area x” (first area), “area y” (second area), and “area z” (third area) according to the degree of trustworthiness. In group 211, “area x” (first area) is an untrusted area, and the degree of trustworthiness thereof is lower than those of “area y” (second area) and “area z” (third area). In addition, “area z” (third area) is a trusted area, and the degree of trustworthiness thereof is higher than those of “area x” (first area) and “area y” (second area). In addition, “area y” (second area) is an intermediate area, and includes communication monitor 311 that monitors communication to “area z” (third area). In other words, group 211 (second group) includes “area y” (software area) that includes communication monitor 311 as a software area.

In the embodiment, communication controller 410 or 411 corresponds to either first communication controller A1 or second communication controller A2. For example, when communication is performed from virtual machine 40 to virtual machine 50, communication controller 410 corresponds to first communication controller A1, and communication controller 411 corresponds to second communication controller A2. Conversely, when communication is performed from virtual machine 50 to virtual machine 40, communication controller 411 corresponds to first communication controller A1, and communication controller 410 corresponds to second communication controller A2.

In addition, communication controller 420 corresponds to third communication controller A3. In addition, in the embodiment, one of communication monitors 310 and 311 corresponds to communication monitor B1. For example, when communication is performed from virtual machine 40 to virtual machine 50, communication monitor 311 corresponds to communication monitor B1. Conversely, when communication is performed from virtual machine 50 to virtual machine 40, communication monitor 310 corresponds to communication monitor B1.

The following describes first communication controller A1, second communication controller A2, third communication controller A3, and communication monitor B1 included in vehicle security system 1 according to the embodiment.

First communication controller A1 manages the first communication related to the software area belonging to the first group of the plurality of groups. In the example shown in FIG. 1, communication controller 410 is first communication controller A1. Communication controller 410 manages communication related to the software area (“area a”, “area b”, or “area c”) belonging to the first group (group 210 of virtual machine 40) of the two groups 210, 211.

Specifically, first communication controller A1 holds “architecture/network information”. When first communication controller A1 receives a message, it refers to the “architecture/network information” to execute a determination process to determine whether the destination of the received message belongs to a group (the first group (here, group 210 of the virtual machines 40)) managed by first communication controller A1 itself.

In the following description, a message may include a request message that requests a message to be sent to a destination, or a response message from the destination to a sender. A request message includes information such as the sender, destination, command (the service desired to be used) and the like. It should be noted that both the sender and destination are only needed to be uniquely identifiable within the vehicle, and may be, for example, an identifier (ID) or internet protocol (IP) address.

The “architecture/network information” includes a list of functions belonging to the first group (here, group 210 of virtual machines 40), information indicating the network configuration up to each function, and information related to first communication controller A1.

If the result of the determination process indicates that the destination of the received message belongs to the first group, first communication controller A1 executes a decision process to decide whether to send the message directly to the destination by referring to the “rule/policy information” held by first communication controller A1. On the other hand, if the received message does not belong to the first group, first communication controller A1 transfers the message to third communication controller A3 (here, communication controller 420). However, when the sender of the received message is third communication controller A3, first communication controller A1 may discard the message in order to avoid an infinite loop of sending and receiving messages.

The “rule/policy information” includes information on the conditions for whether communication with a function belonging to the first group (here, group 210 of virtual machines 40) is permitted. The conditions may include, for example, permitting direct communication to the destination when the degree of trustworthiness of the sender is higher than or equal to that of the destination, denying direct communication to the destination when the degree of trustworthiness of the sender is lower than that of the destination, and the like.

In addition, the conditions may include, for example, permitting direct communication to the destination when the sender belongs to the same partition as the destination, denying direct communication to the destination when the sender belongs to a different partition from the destination, and the like. In addition, the conditions may include, for example, permitting communication by assuming that direct communication to the destination is permitted when the sender of a message is communication monitor B1, and the like. When denying direct communication to the destination, first communication controller A1 sends a message to communication monitor B1 (here, communication monitor 310). It should be noted that, when there is no communication monitor B1 in the group to which first communication controller A1 belongs, first communication controller A1 may send a message to communication monitor B1 of another predetermined group.

Second communication controller A2 manages the second communication related to the software area belonging to the second group of a plurality of groups. In the example shown in FIG. 1, communication controller 411 is second communication controller A2. Communication controller 411 manages the communication related to the software area (“area x”, “area y”, or “area z”) belonging to the second group (group 211 of virtual machine 50) of two groups 210, 211.

Specifically, second communication controller A2 holds “architecture/network information”. When second communication controller A2 receives a message, it the refers to “architecture/network information” to execute a determination process to determine whether the destination of the received message belongs to a group (the second group (here, group 211 of virtual machine 50)) managed by second communication controller A2 itself.

The “architecture/network information” includes a list of functions belonging to the second group (here, group 211 of virtual machine 50), information indicating the network configuration up to each function, and information related to second communication controller A2.

If the result of the determination process indicates that the destination of the received message belongs to the second group, second communication controller A2 executes a decision process to decide whether to send the message directly to the destination by referring to the “rule/policy information” held by second communication controller A2. On the other hand, if the received message does not belong to the second group, second communication controller A2 transfers the message to third communication controller A3 (here, communication controller 420). However, if the sender of the received message is third communication controller A3, second communication controller A2 may discard the message in order to avoid an infinite loop of sending and receiving messages.

The “rule/policy information” includes information on the conditions for whether communication with the functions belonging to the second group (here, group 211 of virtual machine 50) is permitted. The conditions may include, for example, permitting direct communication to the destination when the degree of trustworthiness of the sender is higher than or equal to that of the destination, rejecting direct communication to the destination when the degree of trustworthiness of the sender is lower than that of the destination, and the like. In addition, the conditions may include, for example, permitting direct communication to the destination when the sender belongs to the same partition as the destination, rejecting direct communication to the destination when the sender belongs to a different partition from the destination, and the like. In addition, the conditions may include, for example, permitting communication by assuming that direct communication to the destination is permitted when the sender of a message is communication monitor B1, and the like. When rejecting direct communication to the destination, second communication controller A2 sends a message to communication monitor B1 (here, communication monitor 311). It should be noted that when communication monitor B1 does not exist in the group to which second communication controller A2 belongs, second communication controller A2 may send a message to communication monitor B1 of another predetermined group.

Third communication controller A3 manages communication between the software area belonging to the first group and the software area belonging to the second group, separately from the first communication and the second communication. In the example shown in FIG. 1, communication controller 420 is third communication controller A3. Communication controller 420 manages communication between the software area (“area a”, “area b”, or “area c”) belonging to the first group (group 210 of virtual machines 40) and the software area (“area x”, “area y”, or “area z”) belonging to the second group (group 211 of virtual machines 50).

Specifically, third communication controller A3 holds “architecture/network information”. When third communication controller A3 receives a message, it refers to the “architecture/network information” to execute a determination process to determine whether the destination of the received message belongs to a group (the first group (here, group 210 of virtual machines 40) and the second group (here, group 211 of virtual machines 50)) managed by third communication controller A3 itself.

The “architecture/network information” includes a list of functions belonging to a first group (here, group 210 of virtual machines 40) and information related to first communication controller A1 that manages communication of the first group. In addition, the “architecture/network information” includes a list of functions belonging to a second group (here, group 211 of virtual machines 50) and information related to second communication controller A2 that manages communication of the second group.

If the result of the determination process indicates that the destination of the received message belongs to either the first group or the second group, third communication controller A3 executes a decision process to decide whether to transfer the message to the communication controller that manages the group to which the destination belongs, by referring to the “rule/policy information” held by third communication controller A3. On the other hand, if the received message does not belong to either the first group or the second group, it discards the message.

The “rule/policy information” includes information related to the conditions for whether communication with the first group (here, group 210 of virtual machines 40) and the second group (here, group 211 of virtual machines 50) is permitted. The conditions may include, for example, permitting transfer if the sender belongs to either the first group or the second group, rejecting transfer if the sender belongs to neither the first group nor the second group, and the like.

Communication monitor B1 executes a monitoring process to monitor whether a received message is normal by monitoring the received message at the application level. If communication monitor B1 determines that the received message is normal, it permits communication to the destination of the message. On the other hand, if communication monitor B1 determines that the received message is anomalous, it rejects communication to the destination of the message. In the example shown in FIG. 1, when a message is sent from virtual machine 40 to virtual machine 50, communication monitor 311 is communication monitor B1. In addition, in the example shown in FIG. 1, when a message is sent from virtual machine 50 to virtual machine 40, communication monitor 310 is communication monitor B1.

Specifically, communication monitor B1 may determine that a received message is normal, for example, if the message is included in a communication permission list held by the sender of the received message, and may determine that the message is anomalous if not. In addition, communication monitor B1 may determine that a received message is normal, for example, if the communication volume and frequency of the received message are each above a threshold, and may determine that the message is anomalous if not. In addition, communication monitor B1 may determine that a received message is normal, for example, if the parameters of the received message are as specified, and may determine that the message is anomalous if not. In addition, communication monitor B1 may determine that a received message is normal, for example, if the status of the sender of the received message is normal, and may determine that the message is anomalous if not.

### 2. Communication Examples of Vehicle Security System

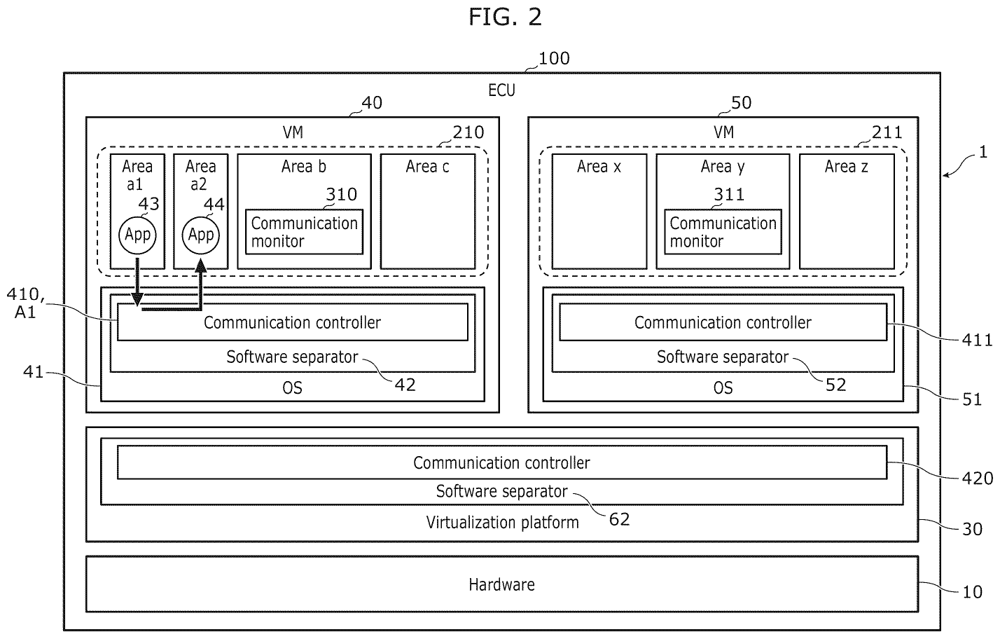

Hereinafter, communication examples of vehicle security system 1 according to the embodiment are listed. Hereinafter, in the explanations and diagrams of each communication example (FIG. 2 to FIG. 25B), applications will be represented as “App”. In addition, in the block diagrams of each communication example (FIGS. 2, 4, 6, 8, 10, 12, 14, 16, 18, 20, 22, 24), message sending paths will be represented by thick arrows.

### 2-1. Communication Example 1

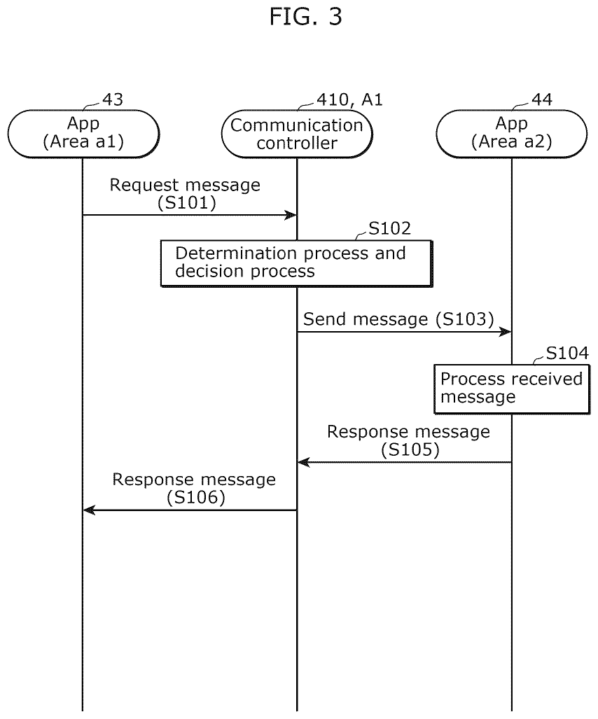

FIG. 2 is a block diagram showing Communication Example 1 of vehicle security system 1 according to the embodiment. FIG. 3 is a sequence diagram showing Communication Example 1 of vehicle security system 1 according to the embodiment. In Communication Example 1, the one or more software areas belonging to group 210 include “area a1” and “area a2” instead of “area a”. “Area a1” and “area a2” are both untrusted areas. In addition, in Communication Example 1, communication controller 410 corresponds to first communication controller A1.

Communication Example 1 is an example of a case where the software area (here, “area a1”) of the sender of a message and the software area (here, “area a2”) of the destination of a message belong to the same group (here, group 210 of virtual machines 40) and these software areas belong to the same partition. In addition, Communication Example 1 is an example of a case where the software area of the sender of a message and the software area of the destination of a message are both untrusted areas.

In Communication Example 1, as shown in FIG. 2, App 43 belongs to “area a1” of virtual machine 40, and App 44 belongs to “area a2” of virtual machine 40. In addition, the degree of trustworthiness of App 43 and the degree of trustworthiness of App 44 are the same.

As shown in FIG. 3, when App 43 communicates with a function other than “area a1” to which it belongs, it needs to communicate via communication controller 410, and so it sends a request message for App 44 to communication controller 410 (S101).

Communication controller 410 executes a determination process to determine whether the destination (App 44) belongs to the first group (group 210 of virtual machines 40) by referring to the “architecture/network information” held by communication controller 410 (S102). Here, since the destination (App 44) belongs to the first group, communication controller 410 executes a decision process to decide whether to send a message directly to the destination (App 44) by referring to the “rule/policy information” held by communication controller 410 (S102). Here, since the degree of trustworthiness of the sender (App 43) is the same as that of the destination (App 44), and the sender (App 43) and the destination (App 44) belong to the same partition, communication controller 410 sends a message directly to the destination (App 44) (S103).

When App 44 receives the message, it implements the prescribed action by processing the received message (S104). For example, if the received message is a message requesting sending of information handled by App 44, App 44 sends a response message including that information to the sender (App 43). The information handled by App 44, that is, information handled by an application belonging to the untrusted area, may include, for example, information about music being played in the vehicle. Here, when App 44 communicates with a function other than “area a2” to which it belongs, it needs to communicate via communication controller 410, and so it sends, to communication controller 410, a response message to App 43 (S105).

Communication controller 410 executes a determination process and a decision process. Although a detailed description is omitted here, communication controller 410 transfers, to the sender (App 43), a response message as a result of the determination process and the decision process (S106).

App 43 receives a response message to the request message and terminates the processing.

### 2-2. Communication Example 2

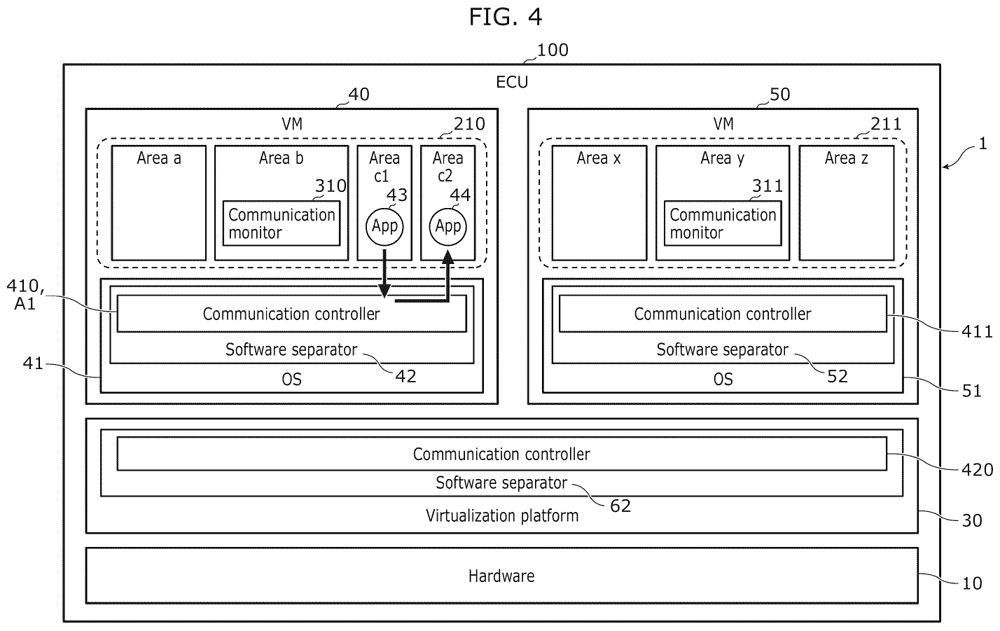

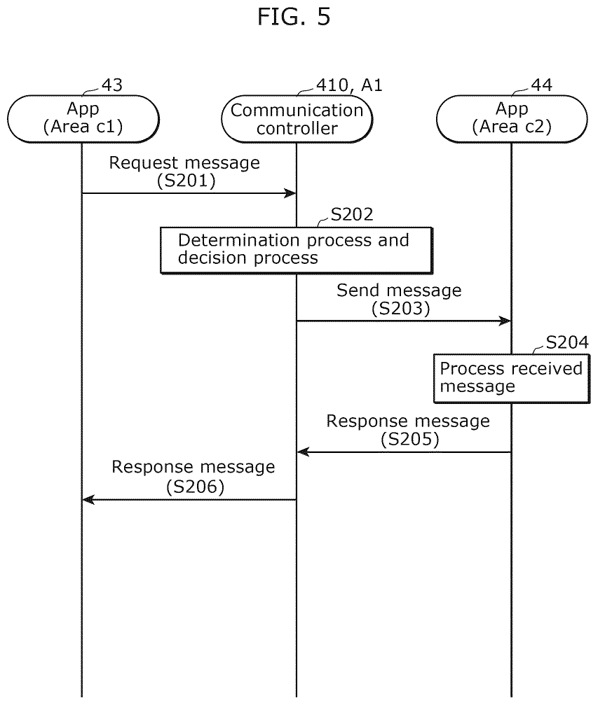

FIG. 4 is a block diagram showing Communication Example 2 of vehicle security system 1 according to the embodiment. FIG. 5 is a sequence diagram showing Communication Example 2 of vehicle security system 1 according to the embodiment. In Communication Example 2, the one or more software areas belonging to group 210 include “area c1” and “area c2” instead of “area c”. “Area c1” and “area c2” are both trusted areas. In addition, in Communication Example 2, communication controller 410 corresponds to first communication controller A1.

Communication Example 2, like Communication Example 1, is an example of a case where the software area (here, “area c1”) of the sender of a message and the software area (here, “area c2”) of the destination of a message belong to the same group (here, group 210 of virtual machines 40) and these software areas belong to the same partition. On the other hand, Communication Example 2 is an example of a case where the software area of the sender of a message and the software area of the destination of a message are both trusted areas.

In Communication Example 2, as shown in FIG. 4, App 43 belongs to “area c1” of virtual machine 40, and App 44 belongs to “area c2” of virtual machine 40. In addition, the degree of trustworthiness of App 43 and the degree of trustworthiness of App 44 are the same.

Step S201 to step S206 shown in FIG. 5 are the same as step S101 to step S106 in FIG. 3 of Communication Example 1 if “area a1” is replaced with “area c1” and “area a2” is replaced with “area c2”, so a description thereof will be omitted here.

### 2-3. Communication Example 3

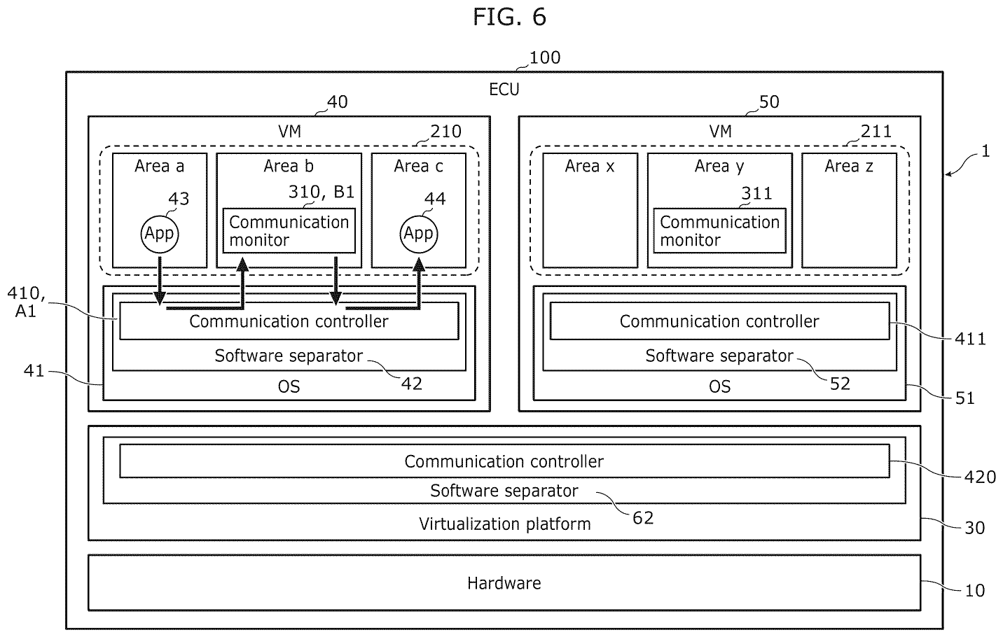

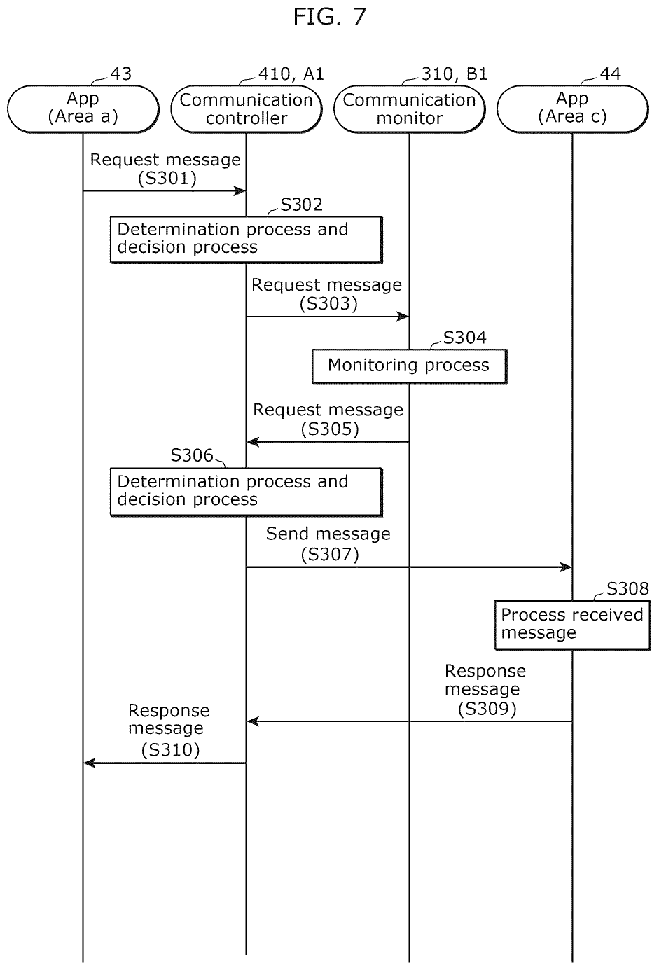

FIG. 6 is a block diagram showing Communication Example 3 of vehicle security system 1 according to the embodiment. FIG. 7 is a sequence diagram showing Communication Example 3 of vehicle security system 1 according to the embodiment. In Communication Example 3, communication controller 410 corresponds to first communication controller A1, and communication monitor 310 corresponds to communication monitor B1.

Communication Example 3 is an example of a case where the software area (here, “area a”) of the sender of a message and the software area (here, “area c”) of the destination of a message belong to the same group (here, group 210 of virtual machines 40), but these software areas belong to different partitions. In addition, Communication Example 3 is an example of a case where the software area of the sender of a message is an untrusted area, but the software area of the destination of a message is a trusted area.

In Communication Example 3, as shown in FIG. 6, App 43 belongs to “area a” of virtual machine 40, and App 44 belongs to “area c” of virtual machine 40. In addition, the degree of trustworthiness of App 43 is lower than that of App 44.

As shown in FIG. 7, when App 43 communicates with a function other than “area a” to which it belongs, it needs to communicate via communication controller 410, and so it sends a request message for App 44 to communication controller 410 (S301).

Communication controller 410 executes a determination process to determine whether the destination (App 44) belongs to the first group (group 210 of virtual machines 40) by referring to the “architecture/network information” held by communication controller 410 (S302). Here, since the destination (App 44) belongs to the first group, communication controller 410 executes a decision process to decide whether to send a message directly to the destination (App 44) by referring to the “rule/policy information” held by communication controller 410 (S302). Here, since the degree of trustworthiness of the sender (App 43) is lower than that of the destination (App 44), and the sender (App 43) and the destination (App 44) belong to different partitions from each other, communication controller 410 rejects direct communication with the destination (App 44) and sends a request message to communication monitor 310 (S303).

Communication monitor 310 executes a monitoring process to monitor whether the received request message is normal by monitoring the received request message at the application level (S304). Here, communication monitor 310 determines that the received request message is normal and permits communication to the destination (App 44) of the request message, and then returns the request message to communication controller 410 (S305).

When communication controller 410 receives a request message from communication monitor 310, it executes a determination process (S306). Here, since the destination (App 44) belongs to the first group, communication controller 410 executes a decision process to decide whether to send a message directly to the destination (App 44) by referring to the “rule/policy information” held by communication controller 410 (S306). Here, since the sender of the message is communication monitor 310, communication controller 410 sends the message directly to the destination (App 44) (S307) by assuming that direct communication to the destination (App 44) is permitted.

When App 44 receives the message, it processes the received message and implements the prescribed action (S308). For example, if the received message is a message requesting sending of information handled by App 44, App 44 sends a response message including that information to the sender (App 43). The information handled by App 44, that is, the information handled by applications belonging to the trusted area, may include vehicle travelling information such as vehicle speed and the like. Here, when App 44 communicates with a function other than “area c” to which it belongs, it needs to communicate via communication controller 410, so it sends, to communication controller 410, a response message to App 43 (S309).

Communication controller 410 executes a determination process and a decision process. Although a detailed description is omitted here, communication controller 410 transfers, to the sender (App 43), a response message as a result of the determination process and the decision process (S310).

App 43 receives a response message to the request message and terminates the processing.

### 2-4. Communication Example 4

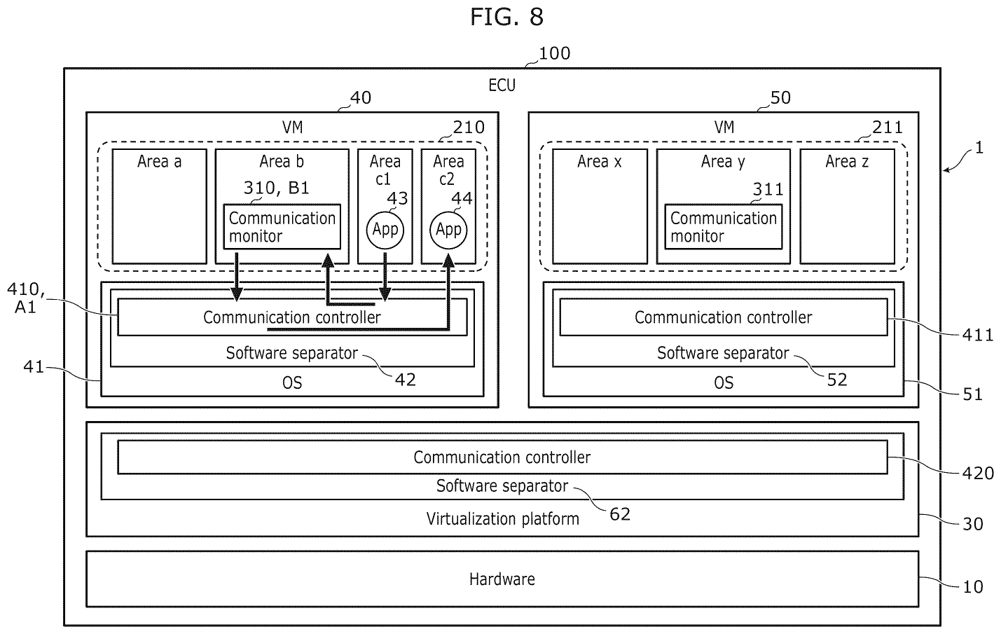

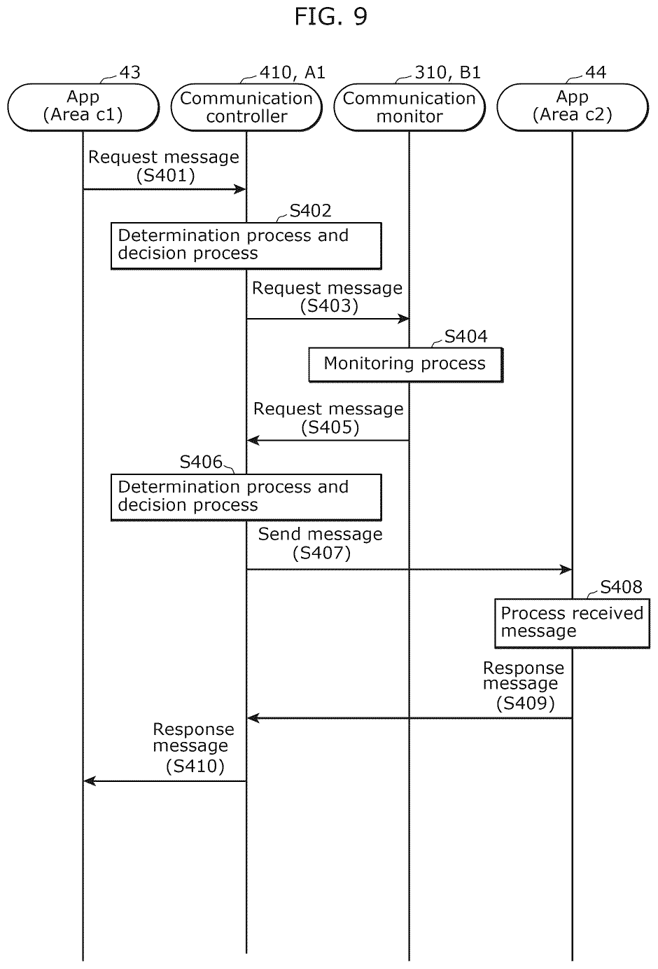

FIG. 8 is a block diagram showing Communication Example 4 of vehicle security system 1 according to the embodiment. FIG. 9 is a sequence diagram showing Communication Example 4 of vehicle security system 1 according to the embodiment. In Communication Example 4, one or more software areas belonging to group 210 include “area c1” and “area c2” instead of “area c”. “Area c1” and “area c2” are both trusted areas. In addition, in Communication Example 4, communication controller 410 corresponds to first communication controller A1, and communication monitor 310 corresponds to communication monitor B1.

Communication Example 4 is an example of a case where the software area (here, “area c1”) of the sender of a message and the software area (here, “area c2”) of the destination of a message belong to the same group (here, group 210 of virtual machine 40), but these software areas belong to different partitions from each other. In addition, Communication Example 4 is an example of a case where the software area of the sender of a message and the software area of the destination of a message are both trusted areas.

In Communication Example 4, as shown in FIG. 8, App 43 belongs to “area c1” of virtual machine 40, and App 44 belongs to “area c2” of virtual machine 40. In addition, the degree of trustworthiness of App 43 and the degree of trustworthiness of App 44 are the same.

Step S401 to step S410 shown in FIG. 9 are basically the same as step S301 to step S310 in FIG. 7 for Communication Example 3 if “area a” is replaced with “area c1” and “area c” is replaced with “area c2”, so a description thereof will be omitted here. However, in steps S402 and S403, the degree of trustworthiness of the sender (App 43) and the degree of trustworthiness of the destination (App 44) are the same but the sender (App 43) and the destination (App 44) belong to different partitions from each other, so communication controller 410 rejects direct communication with the destination (App 44) sends a request message to communication monitor 310.

### 2-5. Communication Example 5

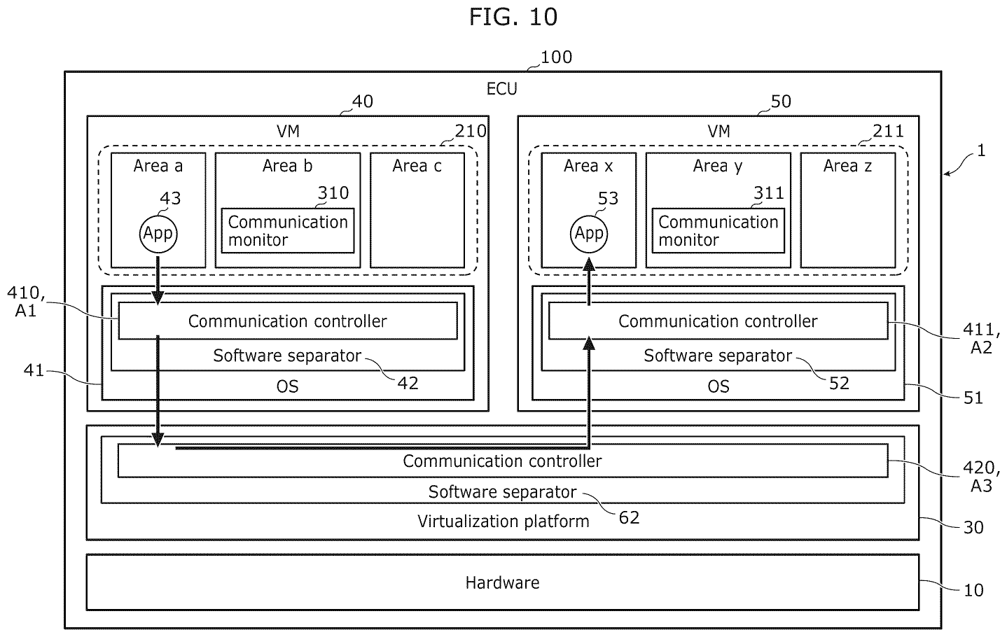

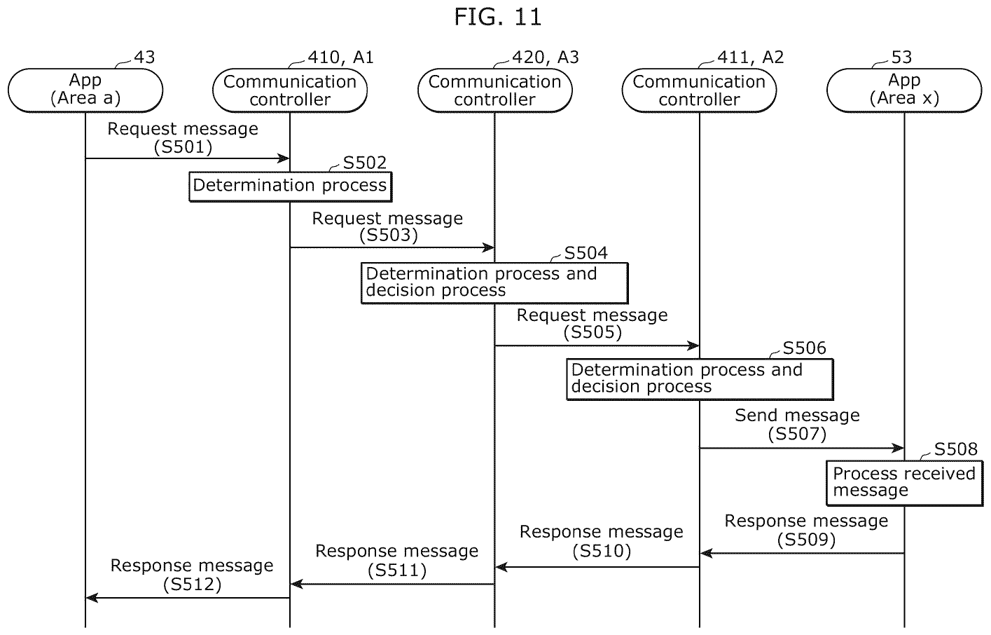

FIG. 10 is a block diagram showing Communication Example 5 of vehicle security system 1 according to the embodiment. FIG. 11 is a sequence diagram showing Communication Example 5 of vehicle security system 1 according to the embodiment. In Communication Example 5, communication controller 410 corresponds to first communication controller A1, communication controller 411 corresponds to second communication controller A2, and communication controller 420 corresponds to third communication controller A3.

Communication Example 5 is an example of a case where the group (here, group 210 of virtual machine 40) to which the software area (here, “area a”) of the sender of a message belongs and the group (here, group 211 of virtual machine 50) to which the software area (here, “area x”) of the destination of a message belongs are different from each other, but these software areas belong to the same partition. In addition, Communication Example 5 is an example of a case where the software area of the sender of a message and the software area of the destination of a message are both untrusted areas.

In Communication Example 5, as shown in FIG. 10, App 43 belongs to “area a” of virtual machine 40, and App 53 belongs to “area x” of virtual machine 50. In addition, the degree of trustworthiness of App 43 and the degree of trustworthiness of App 53 are the same.

As shown in FIG. 11, when App 43 communicates with a function other than “area a” to which it belongs, it needs to communicate via communication controller 410, and so it sends a request message for App 53 to communication controller 410 (S501).

Communication controller 410 executes a determination process to determine whether the destination (App 53) belongs to the first group (group 210 of virtual machines 40) by referring to the “architecture/network information” held by communication controller 410 (S502). Here, since the destination (App 53) does not belong to the first group, communication controller 410 transfers the request message to communication controller 420 (S503).

Communication controller 420 executes a determination process to determine whether the destination (App 53) belongs to the first group (group 210 of virtual machines 40) or the second group (group 211 of virtual machines 50) by referring to the “architecture/network information” held by communication controller 420 (S504). Here, since the destination (App 53) belongs to the second group, communication controller 420 executes a decision process to decide whether to transfer the request message to the communication controller (communication controller 411) that manages the group (group 211 of virtual machines 50) to which the destination (App 53) belongs by referring to the “rule/policy information” held by communication controller 420 (S504). Here, since the sender (App 43) belongs to the first group (group 210 of virtual machines 40), communication controller 420 permits transferring of the request message and transfers the request message to communication controller 411 (S505).

Communication controller 411 executes a determination process to determine whether the destination (App 53) belongs to the second group (group 211 of virtual machines 50) by referring to the “architecture/network information” held by communication controller 411 (S506). Here, since the destination (App 53) belongs to the second group, communication controller 411 executes a decision process to decide whether to send a message directly to the destination (App 53) by referring to the “rule/policy information” held by communication controller 411 (S506). Here, since the degree of trustworthiness of the sender (App 43) is the same as that of the destination (App 53), and the sender (App 43) and the destination (App 53) belong to the same partition, communication controller 411 sends a message directly to the destination (App 53) (S507).

When App 53 receives the message, it implements the prescribed action by processing the received message (S508). For example, if the received message is a message requesting sending of information handled by App 53, App 53 sends a response message including that information to the sender (App 43). Here, when App 53 communicates with a function other than “area x” to which it belongs, it needs to communicate via communication controller 411, and so it sends, to communication controller 411, a response message to App 43 (S509).

Communication controller 411 executes a determination process. Although a detailed description is omitted here, communication controller 411 transfers a response message to communication controller 420 as a result of the determination process (S510).

Communication controller 420 executes a determination process and a decision process. Although a detailed description is omitted here, communication controller 420 transfers a response message as a result of the determination process and the decision process to communication controller 410 (S511).

Communication controller 410 executes a determination process and a decision process. Although a detailed description is omitted here, communication controller 410 transfers a response message to the sender (App 43) as a result of the determination process and the decision process (S512).

App 43 receives a response message to the request message and terminates the processing.

### 2-6. Communication Example 6

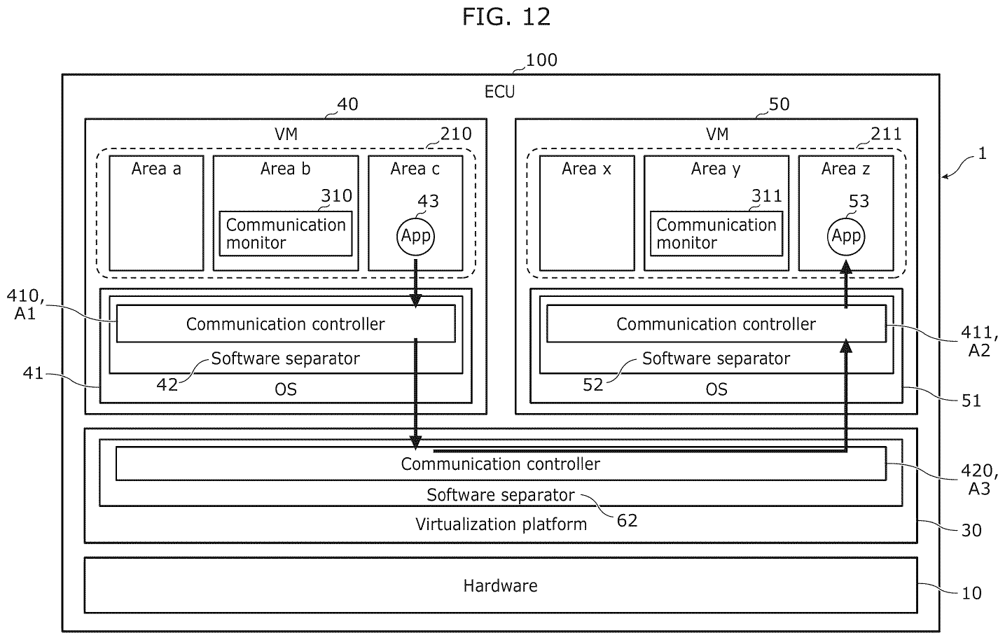

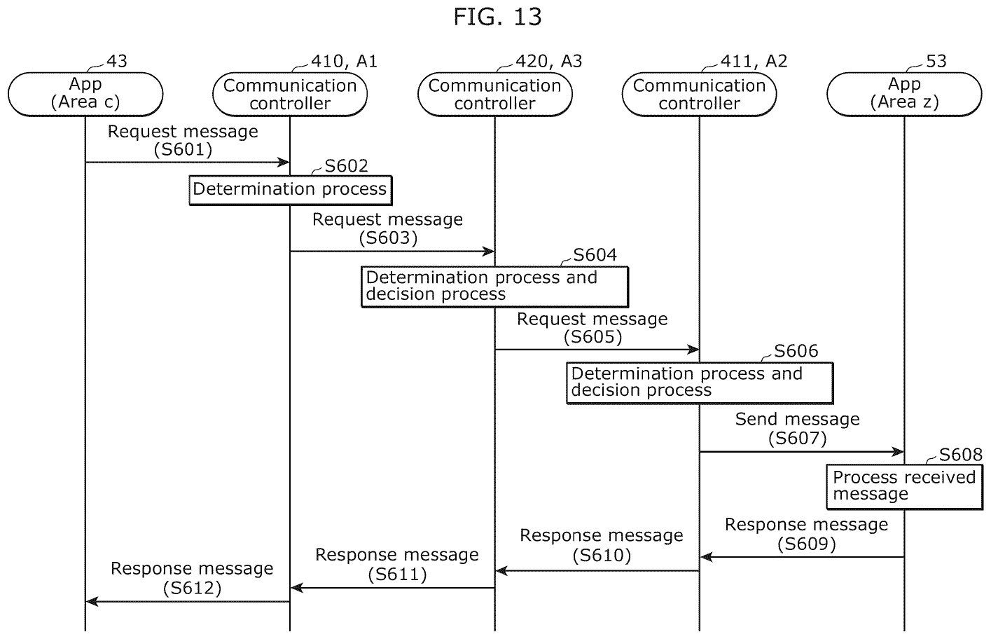

FIG. 12 is a block diagram showing Communication Example 6 of vehicle security system 1 according to the embodiment. FIG. 13 is a sequence diagram showing Communication Example 6 of vehicle security system 1 according to the embodiment. In Communication Example 6, communication controller 410 corresponds to first communication controller A1, communication controller 411 corresponds to second communication controller A2, and communication controller 420 corresponds to third communication controller A3.

Communication Example 6 is an example of a case where the group (here, group 210 of virtual machine 40) to which the software area (here, “area c”) of the sender of a message belongs and the group (here, group 211 of virtual machine 50) to which the software area (here, “area z”) of the destination of a message belongs are different from each other, but these software areas belong to the same partition. In addition, Communication Example 6 is an example of a case where the software area of the sender of a message and the software area of the destination of a message are both trusted areas.

In Communication Example 6, as shown in FIG. 12, App 43 belongs to “area c” of virtual machine 40, and App 53 belongs to “area z” of virtual machine 50. In addition, the degree of trustworthiness of App 43 and the degree of trustworthiness of App 53 are the same.

Step S601 to step S612 shown in FIG. 13 are the same as step S501 to step S512 in FIG. 11 of Communication Example 5 if “area a” is replaced with “area c” and “area x” is replaced with “area z”, so a description thereof will be omitted here.

### 2-7. Communication Example 7

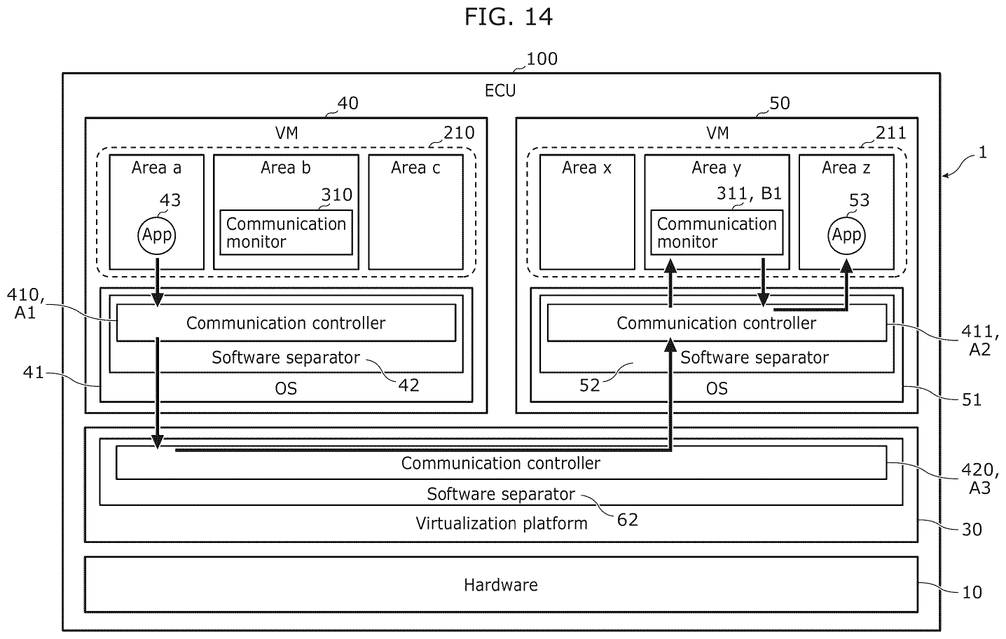

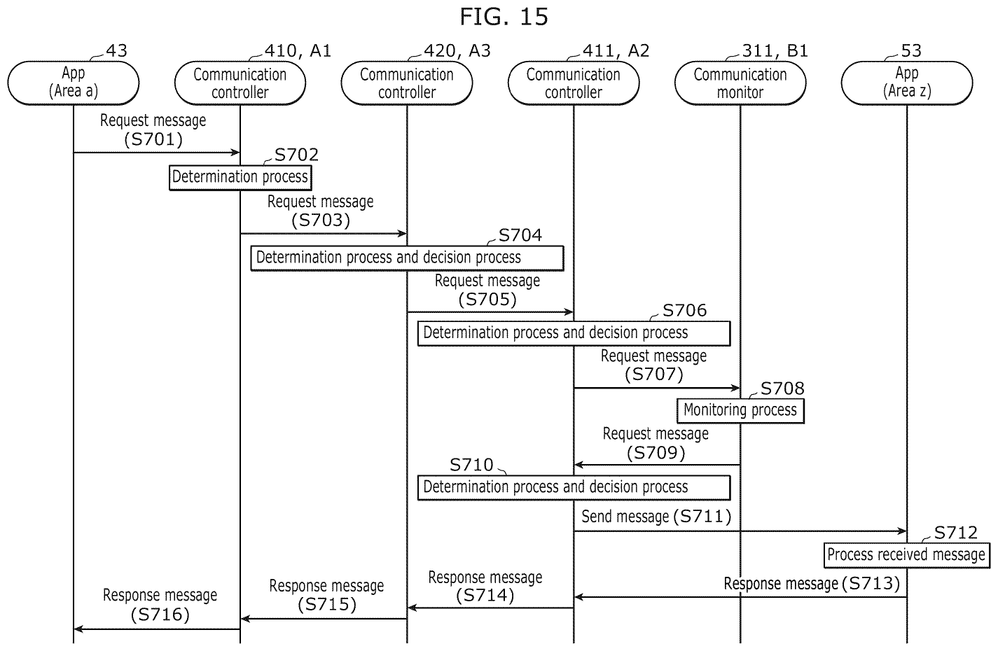

FIG. 14 is a block diagram showing Communication Example 7 of vehicle security system 1 according to the embodiment. FIG. 15 is a sequence diagram showing Communication Example 7 of vehicle security system 1 according to the embodiment. In Communication Example 7, communication controller 410 corresponds to first communication controller A1, communication controller 411 corresponds to second communication controller A2, communication controller 420 corresponds to third communication controller A3, and communication monitor 311 corresponds to communication monitor B1.

Communication Example 7 is an example of a case where the group (here, group 210 of virtual machine 40) to which the software area (here, “area a”) of the sender of a message belongs and the group (here, group 211 of virtual machine 50) to which the software area (here, “area z”) of the destination of a message belongs are different from each other, and these software areas belong to different partitions from each other. In addition, Communication Example 7 is an example of a case where the software area of the sender of a message is an untrusted area, but the software area of the destination of a message is a trusted area.

In Communication Example 7, as shown in FIG. 14, App 43 belongs to “area a” of virtual machine 40, and App 53 belongs to “area z” of virtual machine 50. In addition, the degree of trustworthiness of App 43 is lower than that of App 53.

As shown in FIG. 15, when App 43 communicates with a function other than “area a” to which it belongs, it needs to communicate via communication controller 410, and so it sends a request message for App 53 to communication controller 410 (S701).

Communication controller 410 executes a determination process to determine whether the destination (App 53) belongs to the first group (group 210 of virtual machines 40) by referring to the “architecture/network information” held by communication controller 410 (S702). Here, since the destination (App 53) does not belong to the first group, communication controller 410 transfers the request message to communication controller 420 (S703).

Communication controller 420 executes a determination process to determine whether the destination (App 53) belongs to the first group (group 210 of virtual machines 40) or the second group (group 211 of virtual machines 50) by referring to the “architecture/network information” held by communication controller 420 (S704). Here, since the destination (App 53) belongs to the second group, communication controller 420 executes a decision process to decide whether to transfer the request message to the communication controller (communication controller 411) that manages the group to which the destination (App 53) belongs (group 211 of virtual machines 50) by referring to the “rule/policy information” held by communication controller 420 (S704). Here, since the sender (App 43) belongs to the first group (group 210 of virtual machines 40), communication controller 420 permits transfer of the request message and transfers the request message to communication controller 411 (S705).

Communication controller 411 executes a determination process to determine whether the destination (App 53) belongs to the second group (group 211 of virtual machines 50) by referring to the “architecture/network information” held by communication controller 411 (S706). Here, since the destination (App 53) belongs to the second group, communication controller 411 executes a decision process to decide whether to send a message directly to the destination (App 53) by referring to the “rule/policy information” held by communication controller 411 (S706). Here, since the degree of trustworthiness of the sender (App 43) is lower than that of the destination (App 53) and the sender (App 43) and the destination (App 53) belong to different partitions from each other, communication controller 411 rejects direct communication with the destination (App 53) and sends a request message to communication monitor 311 (S707).

Communication monitor 311 executes a monitoring process to monitor whether the received request message is normal by monitoring the received request message at the application level (S708). Here, communication monitor 311 determines that the received request message is normal and permits communication to the destination of the request message (App 53), and then returns the request message to communication controller 411 (S709).

When communication controller 411 receives a request message from communication monitor 311, it executes a determination process (S710). Here, since the destination (App 53) belongs to the second group, communication controller 411 executes a decision process to decide whether to send a message directly to the destination (App 53) by referring to the “rule/policy information” held by communication controller 411 (S710). Here, since the sender of the message is communication monitor 311, communication controller 411 sends the message directly to the destination (App 53) by assuming that direct communication to the destination (App 53) is permitted (S711).

When App 53 receives a message, it implements the prescribed action by processing the received message (S712). For example, if the received message is a message requesting sending of information handled by App 53, App 53 sends a response message including that information to the sender (App 43). Here, when App 53 communicates with a function other than “area z” to which it belongs, it needs to communicate via communication controller 411, and so it sends, to communication controller 411, a response message to App 43 (S713).

Communication controller 411 executes a determination process. Although a detailed description is omitted here, communication controller 411 transfers a response message to communication controller 420 as a result of the determination process (S714).

Communication controller 420 executes a determination process and a decision process. Although a detailed description is omitted here, communication controller 420 transfers a response message as a result of the determination process and the decision process to communication controller 410 (S715).

Communication controller 410 executes a determination process and a decision process. Although a detailed description is omitted here, communication controller 410 transfers, to the sender, a response message (App 43) as a result of the determination process and the decision process (S716).

App 43 receives a response message to the request message and terminates the processing.

### 2-8. Communication Example 8

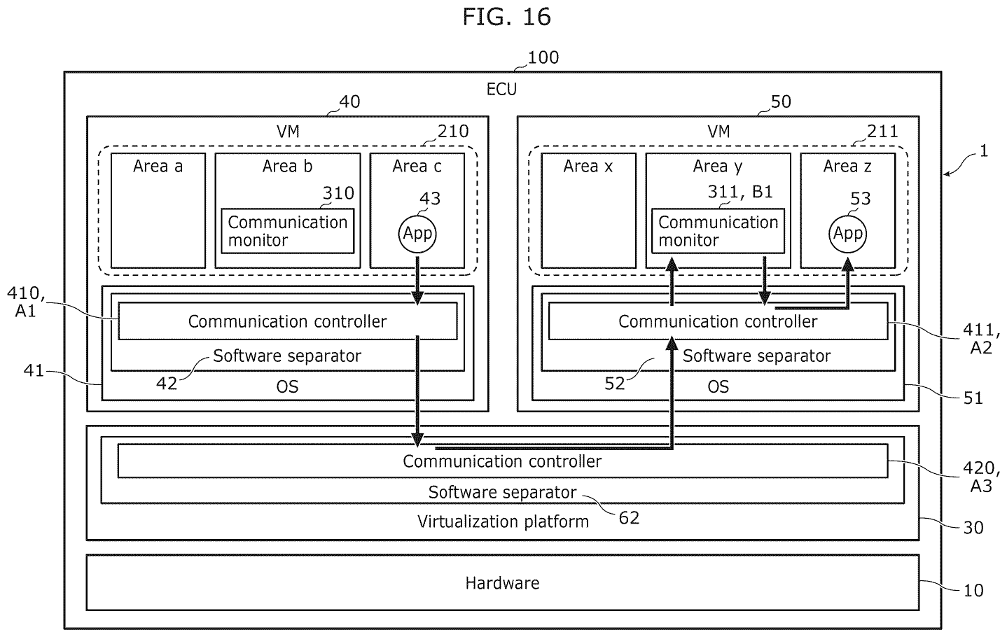

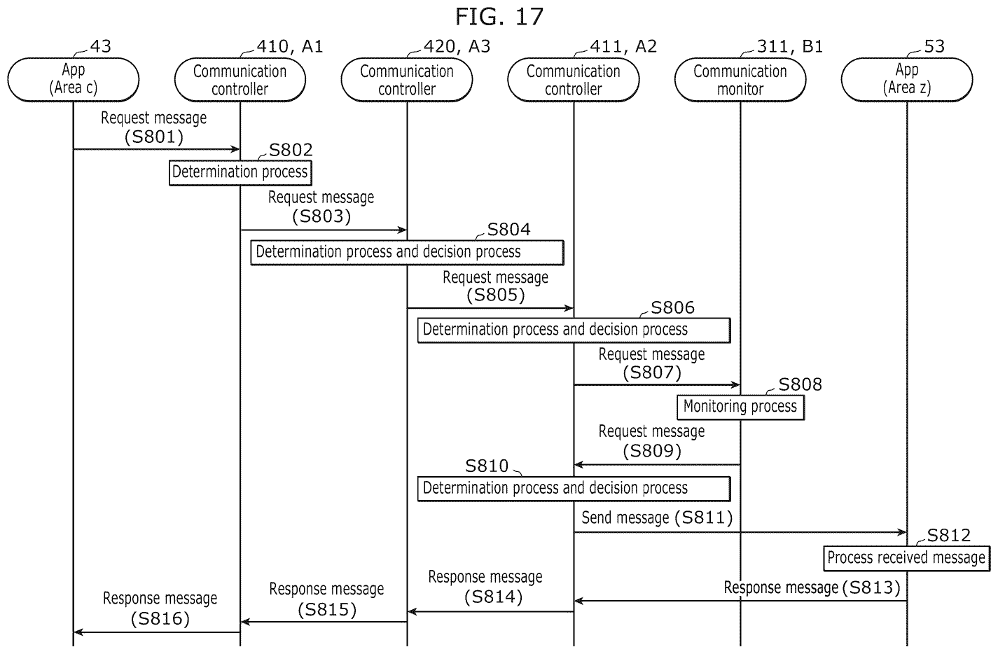

FIG. 16 is a block diagram showing Communication Example 8 of vehicle security system 1 according to the embodiment. FIG. 17 is a sequence diagram showing Communication Example 8 of vehicle security system 1 according to the embodiment. In Communication Example 8, communication controller 410 corresponds to first communication controller A1, communication controller 411 corresponds to second communication controller A2, communication controller 420 corresponds to third communication controller A3, and communication monitor 311 corresponds to communication monitor B1.

Communication Example 8 is an example of a case where the group (here, group 210 of virtual machine 40) to which the software area (here, “area c”) of the sender of a message belongs and the group (here, group 211 of virtual machine 50) to which the software area (here, “area z”) of the destination of a message belongs are different from each other, and these software areas belong to different partitions from each other. In addition, Communication Example 8 is an example of a case where the software area of the sender of a message and the software area of the destination of a message are both trusted areas.

In Communication Example 8, as shown in FIG. 16, App 43 belongs to “area c” of virtual machine 40, and App 53 belongs to “area z” of virtual machine 50. In addition, the degree of trustworthiness of App 43 and the degree of trustworthiness of App 53 are the same.

Step S801 to step S816 shown in FIG. 17 are basically the same as step S701 to step S716 in FIG. 15 for Communication Example 7 if “area a” is replaced with “area c”, so a detailed description will be omitted here. However, in steps S806 and S807, since the degree of trustworthiness of the sender (App 43) and the degree of trustworthiness of the destination (App 53) are the same but the sender (App 43) and the destination (App 53) belong to different partitions from each other, communication controller 411 rejects direct communication to the destination (App 53) and sends a request message to communication monitor 311.

### 2-9. Communication Example 9

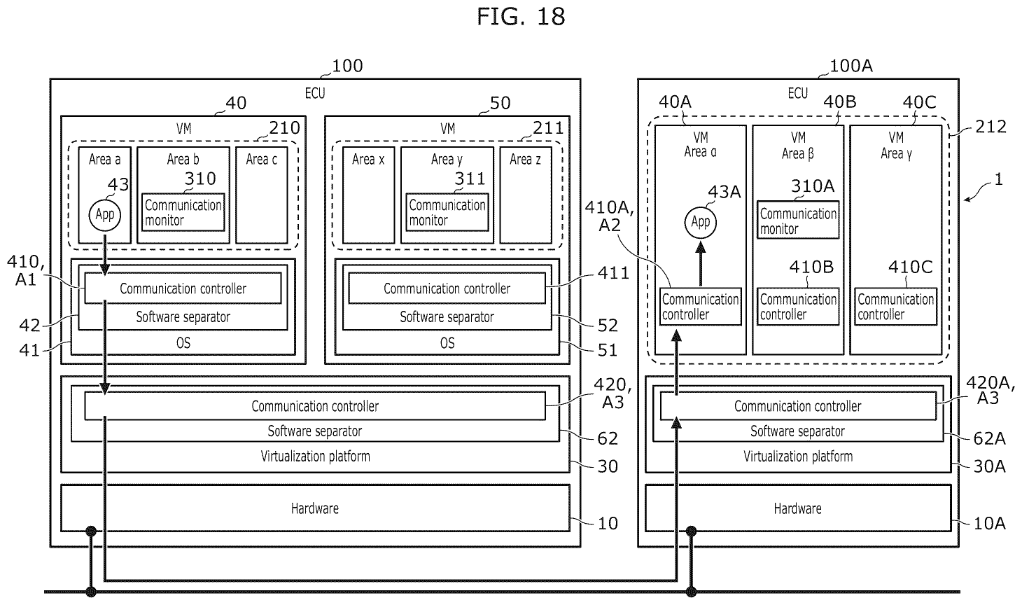

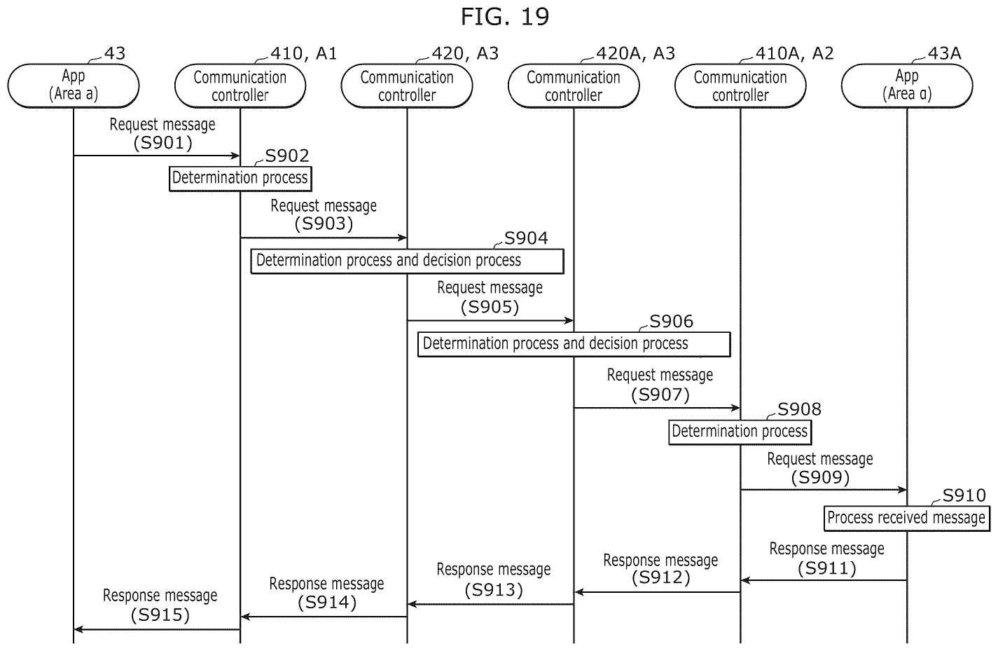

FIG. 18 is a block diagram showing Communication Example 9 of vehicle security system 1 according to the embodiment. FIG. 19 is a sequence diagram showing Communication Example 9 of vehicle security system 1 according to the embodiment. In Communication Example 9 and Communication Examples 10 to 12 listed below, the vehicle includes another ECU 100A in addition to integrated ECU 100, as shown in FIG. 18.

ECU 100A is a computer that includes a processor (microprocessor) and a memory. The memory may be a ROM, a RAM, or the like, and can store a program to be executed by the processor.

ECU 100A includes hardware 10A configured with an SoC, and virtualization platform 30A runs on hardware 10A. One or more virtual machines (here, virtual machines 40A, 40B, and 40C) that are separated from one another are running on virtualization platform 30A.

Hardware 10A is a machine or device that is capable of accepting data, performing logical operations on the data, storing the data in memory, displaying the data on a display, and the like. Hardware 10A may include a processor and a memory. In addition, hardware 10A includes a communication interface for communicating with other hardware in the vehicle, for example via Ethernet, CAN, SPI, or the like.

Virtualization platform 30A is, for example, a hypervisor or the like, and is software that serves as a virtualization infrastructure for running one or more virtual machines (here, virtual machines 40A, 40B, and 40C). Virtualization platform 30A includes software separator 62A that separates the one or more virtual machines. In addition, software separator 62A includes communication controller 420A. Communication controller 420A controls communication that has one of virtual machines 40A, 40B, and 40C as the sender, and communication that has one of virtual machines 40A, 40B, and 40C as the destination. That is, communication to virtual machines 40A, 40B, and 40C is possible only via communication controller 420A.

Virtual machine 40A corresponds to the software area of “area α”. “Area α” is, for example, an untrusted area. In addition, virtual machine 40A includes communication controller 410A.

Communication controller 410A manages communication between “area α” and communication controller 420A.

Virtual machine 40B corresponds to the software area of “area β”. “Area β” is, for example, an intermediate area, and includes communication monitor 310A that monitors communication to functions that belong to “area γ”, which is a trusted area. In addition, virtual machine 40B includes communication controller 410B. Communication controller 410B manages communication between “area β” and communication controller 420A.

Virtual machine 40C corresponds to the software area of “area γ”. “Area γ” is, for example, a trusted area. In addition, virtual machine 40C includes communication controller 410C.

Communication controller 410C manages communication between “area γ” and communication controller 420A.

Here, the software area of virtual machine 40A, the software area of virtual machine 40B, and the software area of virtual machine 40C belong to group 212, which is different from groups 210 and 211. That is, in Communication Examples 9 to 12, there exists group 210 of virtual machine 40 of integrated ECU 100, group 211 of virtual machine 50 of integrated ECU 100, and group 212 of ECU 100A. In Communication Examples 9 to 12, integrated ECU 100 (device) including group 210 (first group) and ECU 100A (device) including group 212 (second group) are different from each other.

In Communication Example 9, communication controller 410 corresponds to first communication controller A1, communication controller 410A corresponds to second communication controller A2, and communication controller 420 and communication controller 420A correspond to third communication controller A3.

Communication Example 9 is an example of a case where the group (here, group 210 of virtual machine 40) to which the software area (here, “area α”) of the sender of a message belongs and the group (here, group 212 of ECU 100A) to which the software area (here, “area α”) of the destination of a message belongs are different from each other, but these software areas belong to the same partition. In addition, Communication Example 9 is an example of a case where both the software area of the sender of a message and the software area of the destination of a message are untrusted domains.

In Communication Example 9, as shown in FIG. 18, App 43 belongs to “area α” of virtual machine 40, and App 43A belongs to “area α” of ECU 100A. In addition, the degree of trustworthiness of App 43 and the degree of trustworthiness of App 43A are the same.

As shown in FIG. 19, when App 43 communicates with a function other than “area α” to which it belongs, it needs to communicate via communication controller 410, and so it sends a request message for App 43A to communication controller 410 (S901).

Communication controller 410 executes a determination process to determine whether the destination (App 43A) belongs to the first group (group 210 of virtual machines 40) by referring to the “architecture/network information” held by communication controller 410 (S902). Here, since the destination (App 43A) does not belong to the first group, communication controller 410 transfers the request message to communication controller 420 (S903).

Communication controller 420 executes a determination process to determine whether the destination (App 43A) belongs to the group (groups 210, 211) included in the device (integrated ECU 100) that includes communication controller 420 itself, or to the group (group 212) included in the other device (ECU 100A) by referring to the “architecture/network information” held by communication controller 420 (S904). Here, since the destination (App 43A) belongs to the group (group 212) included in the other device (ECU 100A), communication controller 420 executes a decision process to decide whether to transfer the request message to the communication controller (communication controller 420A) included in the other device (ECU 100A) by referring to the “rule/policy information” held by communication controller 420 (S904). Here, since the sender (App 43) belongs to the first group (group 210 of virtual machine 40), communication controller 420 permits the transfer of the request message and transfers the request message to communication controller 420A via hardware 10, 10A (S905).

Communication controller 420A executes a determination process to determine whether the destination (App 43A) belongs to the second group (group 212 of ECU 100A) by referring to the “architecture/network information” held by communication controller 420A (S906). Here, since the destination (App 43A) belongs to the second group, communication controller 420A executes a decision process to decide whether to send a message directly to the destination (App 43A) by referring to the “rule/policy information” held by communication controller 420A (S906). Here, since the degree of trustworthiness of the sender (App 43) is the same as that of the destination (App 43A), and the sender (App 43) and the destination (App 43A) belong to the same partition, communication controller 420A transfers the request message to communication controller 410A that manages “area α” to which the destination (App 43A) belongs (S907).

Communication controller 410A executes a determination process to determine whether the destination (App 43A) belongs to the second group (group 212 of ECU 100A) by referring to the “architecture/network information” held by communication controller 410A (S908). Here, since the destination (App 43A) belongs to the second group, communication controller 410A sends the message directly to the destination (App 43A) (S909).

When App 43A receives a message, it implements the prescribed action by processing the received message (S910). For example, if the received message is a message requesting sending of information handled by App 43A, App 43A sends a response message including that information to the sender (App 43). Here, when App 43A communicates with a function other than “area α” to which it belongs, it needs to communicate via communication controllers 410A, 420A, so it first sends, to communication controller 410A, a response message to App 43 (S911).

Communication controller 410A executes a determination process. Although a detailed description is omitted here, communication controller 410A transfers a response message to communication controller 420A as a result of the determination process (S912).

Communication controller 420A executes the determination process and the decision process. Although the detailed description is omitted here, communication controller 420A transfers a response message as a result of the determination process and the decision process to communication controller 420 via hardware 10, 10A (S913).

Communication controller 420 executes a determination process and a decision process. Although a detailed description is omitted here, communication controller 420 transfers a response message to communication controller 410 as a result of the determination process and the decision process (S914).

Communication controller 410 executes a determination process and a decision process. Although a detailed description is omitted here, communication controller 410 transfers a response message to the sender (App 43) as a result of the determination process and the decision process (S915).

App 43 receives a response message to the request message and terminates the processing.

### 2-10. Communication Example 10

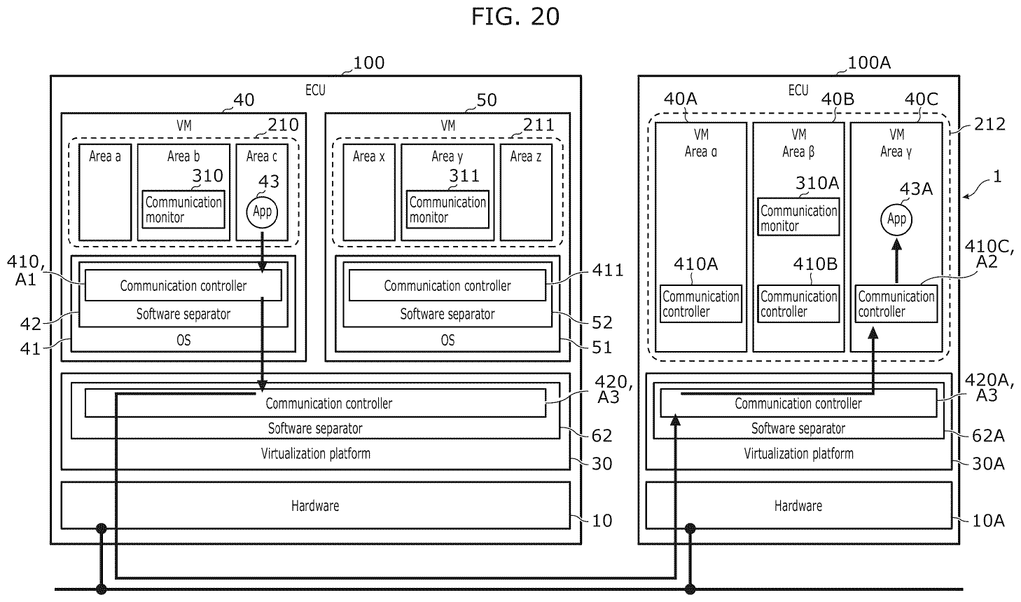

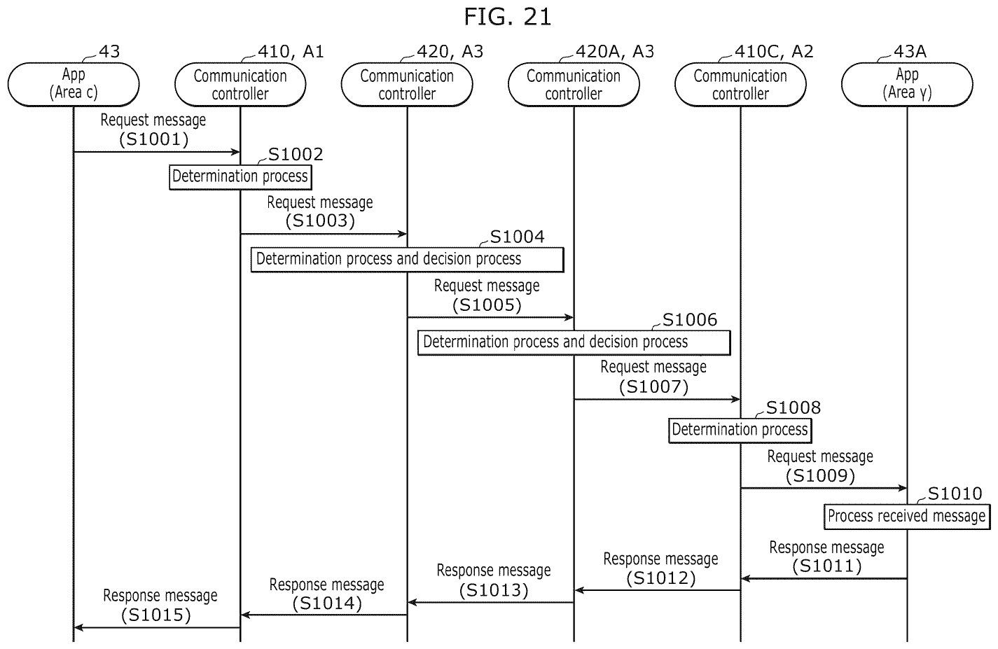

FIG. 20 is a block diagram showing Communication Example 10 of vehicle security system 1 according to the embodiment. FIG. 21 is a sequence diagram showing Communication Example 10 of vehicle security system 1 according to the embodiment. In Communication Example 10, communication controller 410 corresponds to first communication controller A1, communication controller 410C corresponds to second communication controller A2, and communication controller 420 and communication controller 420A correspond to third communication controller A3.

Communication Example 10 is an example of a case where the group (here, group 210 of virtual machine 40) to which the software area (here, “area c”) of the sender of a message belongs and the group (here, group 212 of ECU 100A) to which the software area (here, “area γ”) of the destination of a message belongs are different from each other, but these software areas belong to the same partition. In addition, Communication Example 10 is an example of a case where the software area of the sender of a message and the software area of the destination of a message are both trusted areas.

In Communication Example 10, as shown in FIG. 20, App 43 belongs to “area c” of virtual machine 40, and App 43A belongs to “area γ” of ECU 100A. In addition, the degree of trustworthiness of App 43 and the degree of trustworthiness of App 43A are the same.

Step S1001 to step S1015 shown in FIG. 21 are the same as step S901 to step S915 in FIG. 19 of Communication Example 9 if “area α” is replaced with “area c” and “area α” is replaced with “area Y”, so a description thereof will be omitted here.

### 2-11. Communication Example 11

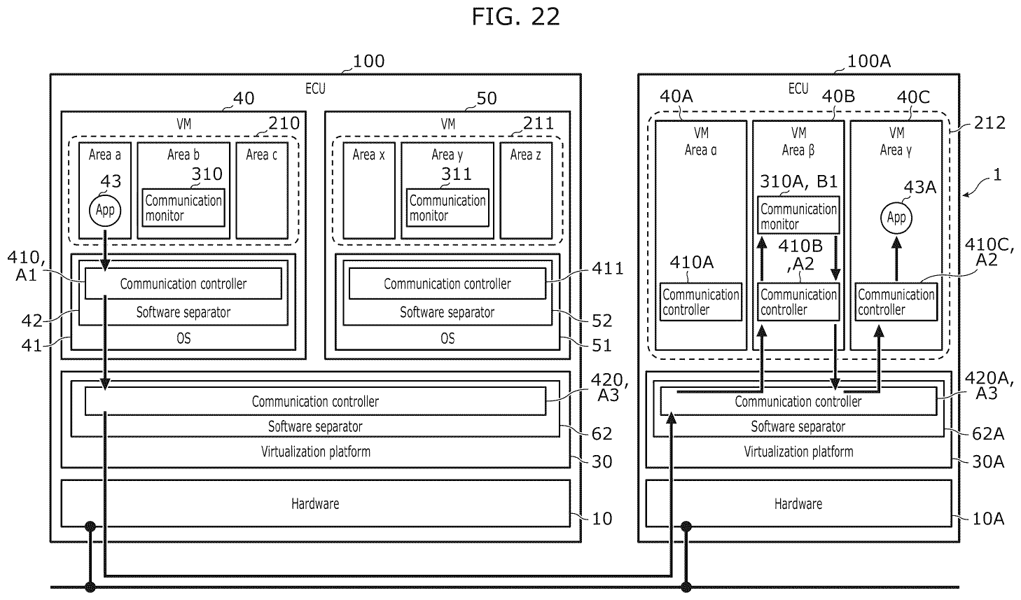

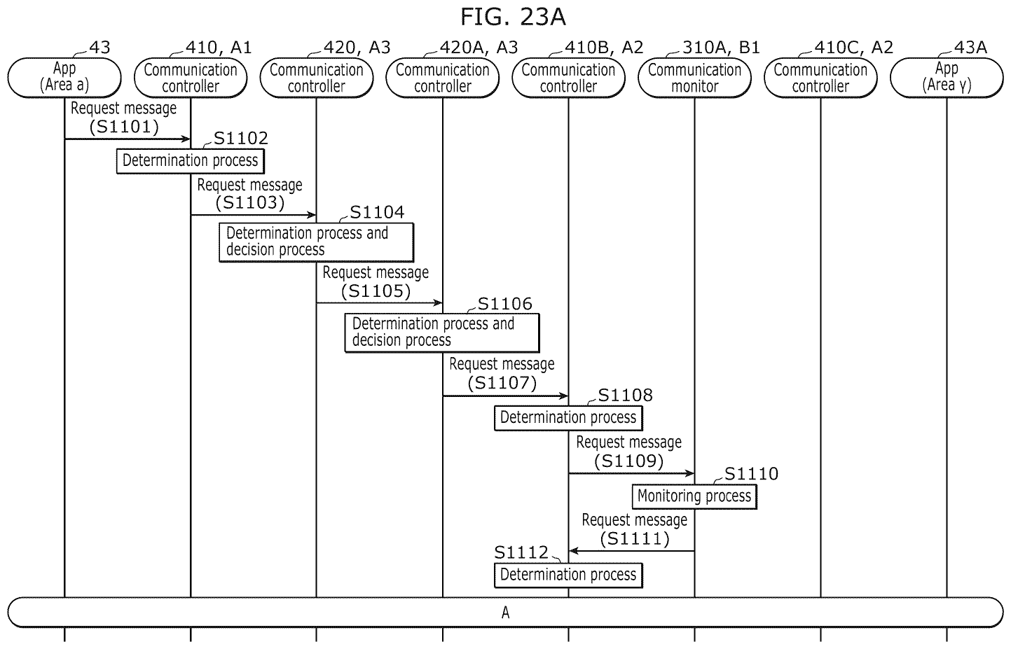

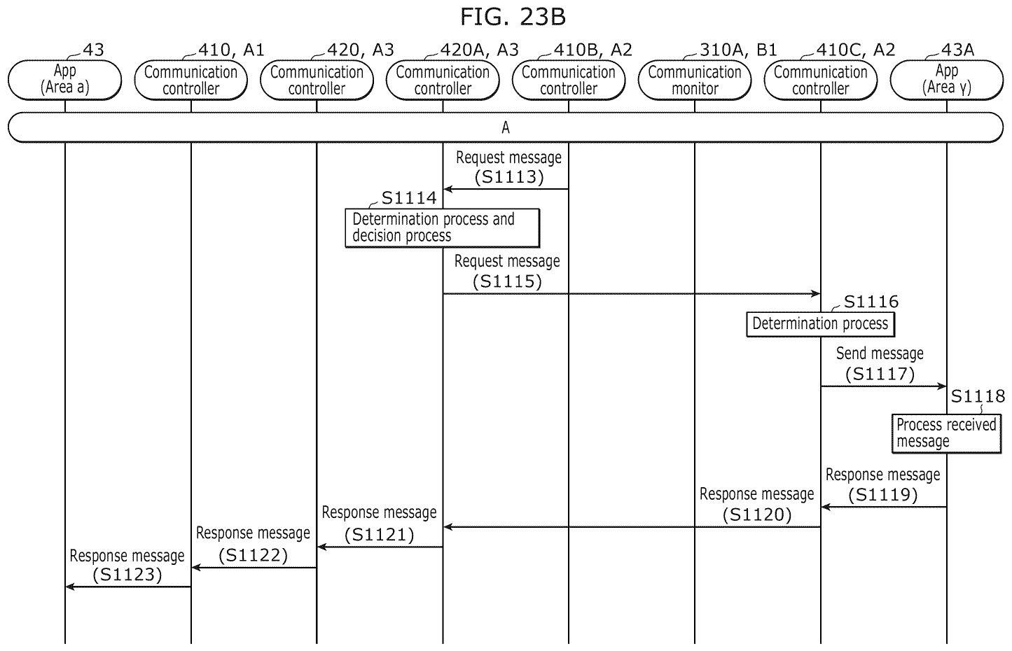

FIG. 22 is a block diagram showing Communication Example 11 of vehicle security system 1 according to the embodiment. FIG. 23A and FIG. 23B are both sequence diagrams showing Communication Example 11 of vehicle security system 1 according to the embodiment. It should be noted that “A” at the bottom of FIG. 23A indicates that the sequence diagram is connected to “A” at the top of FIG. 23B.

In Communication Example 11, communication controller 410 corresponds to first communication controller A1, communication controller 410B and communication controller 410C correspond to second communication controller A2, communication controller 420 and communication controller 420A correspond to third communication controller A3, and communication monitor 310A corresponds to communication monitor B1.

Communication Example 11 is an example of a case where the group (here, group 210 of virtual machine 40) to which the software area (here, “area α”) of the sender of a message belongs and the group (here, group 212 of ECU 100A) to which the software area (here, “area γ”) of the destination of a message belongs are different from each other, and these software areas belong to different partitions from each other. In addition, Communication Example 11 is an example of a case where the software area of the sender of a message is an untrusted area, and the software area of the destination of a message is a trusted area.

In Communication Example 11, as shown in FIG. 22, App 43 belongs to “area α” of virtual machine 40, and App 43A belongs to “area γ” of ECU 100A. In addition, the degree of trustworthiness of App 43 is lower than that of App 43A.

As shown in FIG. 23A and FIG. 23B, when App 43 communicates with a function other than “area α” to which it belongs, it needs to communicate via communication controller 410, and so it sends a request message for App 43A to communication controller 410 (S1101).

Communication controller 410 executes a determination process to determine whether the destination (App 43A) belongs to the first group (group 210 of virtual machines 40) by referring to the “architecture/network information” held by communication controller 410 (S1102). Here, since the destination (App 43A) does not belong to the first group, communication controller 410 transfers the request message to communication controller 420 (S1103).

Communication controller 420 executes a determination process to determine whether the destination (App 43A) belongs to the group (groups 210, 211) included in the device (integrated ECU 100) that includes communication controller 420 itself, or to the group (group 212) included in the other device (ECU 100A) by referring to the “architecture/network information” held by communication controller 420 (S1104). Here, since the destination (App 43A) belongs to the group (group 212) included in the other device (ECU 100A), communication controller 420 executes a decision process to decide whether to transfer the request message to the communication controller (communication controller 420A) included in the other device (ECU 100A) by referring to the “rule/policy information” held by communication controller 420 (S1104). Here, since the sender (App 43) belongs to the first group (group 210 of virtual machine 40), communication controller 420 permits the transfer of the request message and transfers the request message to communication controller 420A via hardware 10, 10A (S1105).

Communication controller 420A executes a determination process to determine whether the destination (App 43A) belongs to the second group (group 212 of ECU 100A) by referring to the “architecture/network information” held by communication controller 420A (S1106). Here, since the destination (App 43A) belongs to the second group, communication controller 420A executes a decision process to decide whether to send a message directly to the destination (App 43A) by referring to the “rule/policy information” held by communication controller 420A (S1106). Here, since the degree of trustworthiness of the sender (App 43) is lower than that of the destination (App 43A), and the sender (App 43) and the destination (App 43A) belong to different partitions from each other, communication controller 420A rejects direct communication to the destination (App 43A) and sends a request message to communication controller 410B that manages “area β” in which communication monitor 310A is located (S1107).

Communication controller 410B executes a determination process to determine whether the destination (App 43A) belongs to the second group (group 212 of ECU 100A) by referring to the “architecture/network information” held by communication controller 410B (S1108). Here, since the destination (App 43A) belongs to the second group, communication controller 410B sends a request message to communication monitor 310A (S1109).

Communication monitor 310A executes a monitoring process to monitor whether the received request message is normal by monitoring the received request message at the application level (S1110). Here, communication monitor 310A determines that the received request message is normal and permits communication to the destination of that request message (App 43A), and then returns the request message to communication controller 410B (S1111).

Communication controller 410B executes a determination process (S1112). Although a detailed description is omitted here, communication controller 410B transfers a response message to communication controller 420A as a result of the determination process (S1113).

When communication controller 420A receives the request message, it executes a determination process (S1114). Here, since the destination (App 43A) belongs to the second group, communication controller 420A executes a decision process to decide whether to send a message directly to the destination (App 43A) by referring to the “rule/policy information” held by communication controller (S1115). Here, since the sender of the message is communication monitor 310A, communication controller 420A transfers the request message to communication controller 410C that manages “area γ” to which the destination (App 43A) belongs by assuming that direct communication to the destination (App 43A) is permitted (S1115).

Communication controller 410C executes a determination process to determine whether the destination (App 43A) belongs to the second group (group 212 of ECU 100A) by referring to the “architecture/network information” held by communication controller 410C (S1116). Here, since the destination (App 43A) belongs to the second group, communication controller 410C sends the message directly to the destination (App 43A) (S1117).

When App 43A receives a message, it implements the prescribed action by processing the received message (S1118). For example, when the received message is a message requesting sending of information handled by App 43A, App 43A sends a response message including that information to the sender (App 43). Here, when App 43A communicates with a function other than “area Y” to which it belongs, it needs to communicate via communication controllers 410C, 420A, so it first sends, to communication controller 410C, a response message to App 43 (S1119).

Communication controller 410C executes a determination process. Although a detailed description is omitted here, communication controller 410C transfers a response message to communication controller 420A as a result of the determination process (S1120).

Communication controller 420A executes a determination process and a decision process. Although the detailed description is omitted here, communication controller 420A transfers a response message to communication controller 420 via hardware 10, 10A as a result of the determination process and the decision process (S1121).

Communication controller 420 executes a determination process and a decision process. Although a detailed description is omitted here, communication controller 420 transfers a response message to communication controller 410 as a result of the determination process and the decision process (S1122).

Communication controller 410 executes a determination process and a decision process. Although a detailed description is omitted here, communication controller 410 transfers a response message to the sender (App 43) as a result of the determination process and the decision process (S1123).

App 43 receives a response message to the request message and terminates the processing.

### 2-12. Communication Example 12

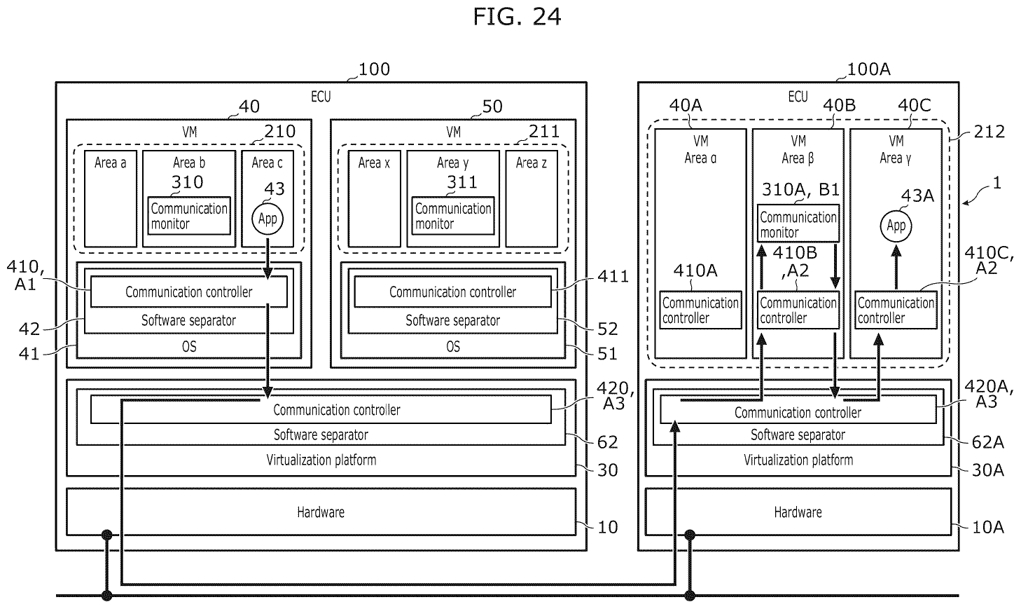

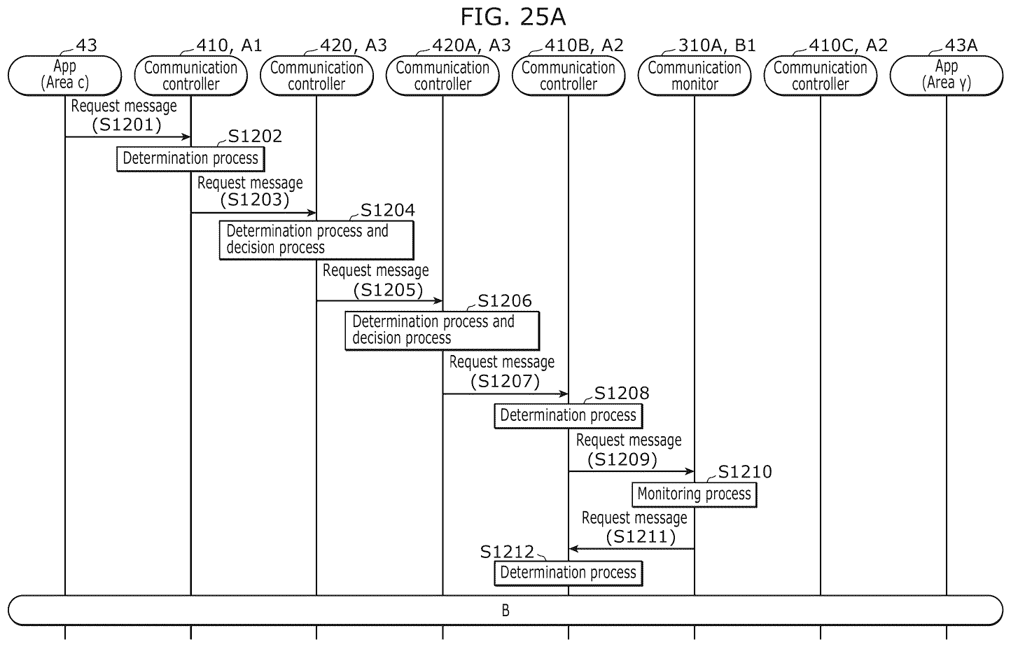

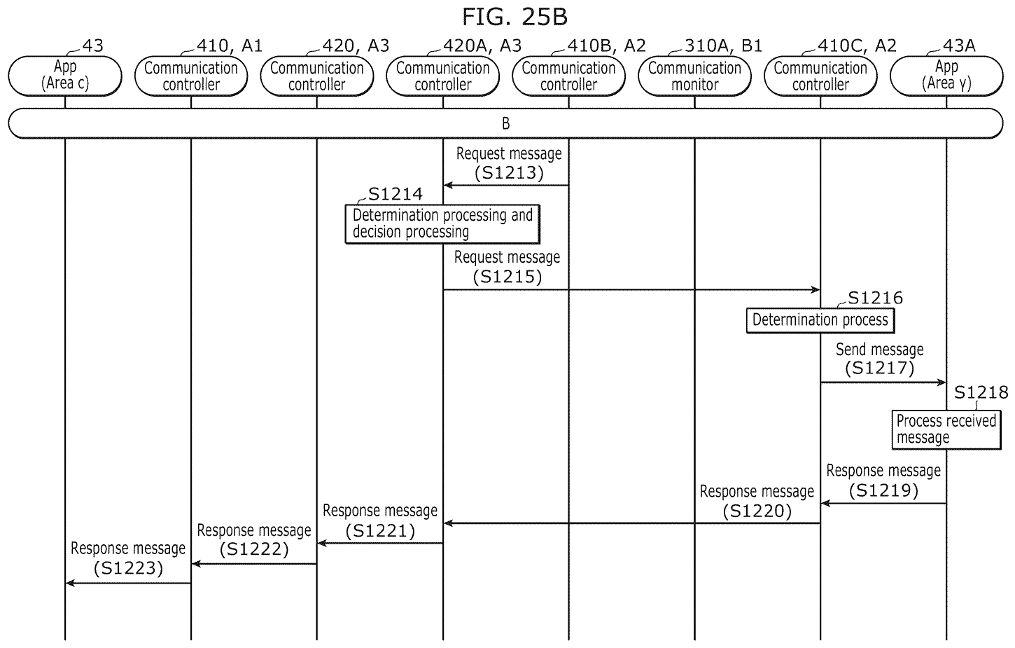

FIG. 24 is a block diagram showing Communication Example 12 of vehicle security system 1 according to the embodiment. FIG. 25A and FIG. 25B are both sequence diagrams showing Communication Example 12 of vehicle security system 1 according to the embodiment. It should be noted that “B” at the bottom of FIG. 25A indicates that the sequence diagram is connected to “B” at the top of FIG. 25B.

In Communication Example 12, communication controller 410 corresponds to first communication controller A1, communication controller 410B and communication controller 410C correspond to second communication controller A2, communication controller 420 and communication controller 420A correspond to third communication controller A3, and communication monitor 310A corresponds to communication monitor B1.

Communication Example 12 is an example of a case where the group (here, group 210 of virtual machine 40) to which the software area (here, “area c”) of the sender of a message belongs and the group (here, group 212 of ECU 100A) to which the software area (here, “area γ”) of the destination of a message belongs are different from each other, and these software areas belong to different partitions from each other. In addition, Communication Example 12 is an example of a case where the software area of the sender of a message and the software area of the destination of a message are both trusted areas.

In Communication Example 12, as shown in FIG. 24, App 43 belongs to “area c” of virtual machine 40, and App 43A belongs to “area γ” of ECU 100A. In addition, the degree of trustworthiness of App 43 and the degree of trustworthiness of App 43A are the same.

Step 1201 to step 1223 shown in FIG. 25A and FIG. 25B are basically the same as step S1101 to step S1123 in FIG. 23A and FIG. 23B of Communication Example 11 if “area α” is replaced with “area c”, so a description thereof will be omitted here. However, in steps S1206 and S1207, since the degree of trustworthiness of the sender (App 43) and the degree of trustworthiness of the destination (App 43A) are the same, but the sender (App 43) and the destination (App 43A) belong to different partitions from each other, communication controller 420 rejects direct communication to the destination (App 43A) and sends a request message to communication controller 410B that manages “area β” where communication monitor 310A is located.

### 3. Advantages

Advantages of vehicle security system 1 according to the embodiment will be described below. As mentioned above, vehicle security system 1 according to the embodiment separates the first communication related to the software area belonging to the first group from the second communication related to the software area belonging to the second group, so that the effects of processing in one group do not affect the processing in the other group. For example, even in a case where a software update is performed on a function belonging to group 210 (first group), the effect on the function belonging to group 210 is limited by first communication controller A1, and there is no effect on the other group 211 (second group). For this reason, vehicle security system 1 according to the embodiment can easily keep the effects of the above processing to a minimum, so that it has the advantage of making it easier to ensure partition separation while suppressing operating costs.

In addition, in vehicle security system 1 according to the embodiment, separately from the first communication and the second communication, communication from a software area belonging to the first group to a software area belonging to the second group is possible only via third communication controller A3. For this reason, in vehicle security system 1 according to the embodiment, management of communication across groups (virtual machines) within the device (integrated ECU 100) or communication across the device (integrated ECU 100) and another device (ECU 100A) is also easily expandable. That is, vehicle security system 1 according to the embodiment has an advantage that partition separation can be also applied to an in-vehicle system including a plurality of virtual machines while suppressing operating costs.

### Other Embodiments

As described above, the embodiment has been described as an example of the technology according to the present disclosure. However, the technology according to the present disclosure is not limited thereto, and can be applied to embodiments in which modifications, substitutions, additions, omissions, and the like are made as appropriate. For example, the following variations are also included in one embodiment of the present disclosure.

For example, in the above embodiment, integrated ECU 100 includes two groups, but may include three or more groups. In addition, in the above embodiment, the groups are configured on a virtual machine basis, but they may be configured on a container basis, or may be configured with a mixture of virtual machines and containers.

For example, in the above embodiment, the group includes three software areas, but it may have two or less software areas, or it may have four or more software areas.

For example, in the above embodiment, examples in which vehicle security system 1 is realized by integrated ECU 100 (Communication Example 1 to Communication Example 8), and examples in which vehicle security system 1 is realized by integrated ECU 100 and ECU 100A (Communication Example 9 to Communication Example 12) have been described, but it is not limited thereto and vehicle security system 1 may also be realized by high-performance computing (HPC).

In addition, the order in which each step is executed in the sequence diagram is merely an example for specifically explaining the present disclosure, and an order other than the above may be used. In addition, some of the above steps may be executed simultaneously (in parallel) with other steps, or some of the above steps may not be executed.

In addition, the division of functional blocks in a block diagram is one example, and a plurality of functional blocks may be realized as one functional block, one functional block may be divided into a plurality of blocks, or some functions may be transferred to other functional blocks. In addition, the functions of a plurality of functional blocks including similar functions may be processed in parallel or in a time-sharing manner by a single piece of hardware or software.

In addition, each of the components described in the above embodiment and the like may be realized as software, or may be typically realized as an LSI, which is an integrated circuit. These may be individually integrated into one chip, or may be integrated into one chip so as to contain some or all of the components. It is referred to as an LSI here, but depending on the degree of integration, it may be called an IC, system LSI, super LSI, or ultra LSI. In addition, the method of integration is not limited to LSI, and may be realized with a dedicated circuit (a general-purpose circuit that executes a dedicated program) or a general-purpose processor. Field programmable gate arrays (FPGAs) that can be programmed after the LSI is manufactured, or a reconfigurable processor that is capable of reconfiguring the connections or settings of circuit cells within an LSI may be used. Furthermore, if an integrated circuit technology that replaces an LSI appears due to advances in semiconductor technology or another technology derived therefrom, it is natural that the components may be integrated using that technology.

A system LSI is an ultra-multifunctional LSI manufactured by integrating a plurality of processors onto a single chip, and specifically, is a computer system that is configured to include a microprocessor, ROM, RAM, and the like. Computer programs are stored in the ROM. The system LSI achieves its functions by the microprocessor operating in accordance with the computer program.

In addition, one aspect of the present disclosure may be a computer program that causes a computer to execute each of the characteristic steps included in the security method shown in any of Communication Example 1 to Communication Example 12 described above.

In addition, for example, the program may be a program for causing a computer to execute. In addition, one aspect of the present disclosure may be a computer-readable non-transitory recording medium having recorded thereon such a program. For example, such a program may be recorded on a recording medium and distributed or circulated. For example, by installing the distributed program in a device including another processor and having the program executed by that processor, it becomes possible to cause the device to perform each of the above processes.

In addition, forms obtained by applying various modifications to the embodiment conceived by a person skilled in the art or forms realized by arbitrarily combining the components and functions in each embodiment without departing from the spirit of the present disclosure are also included in this disclosure.

### Conclusion

As mentioned above, vehicle security system 1 according to Aspect 1 is vehicle security system 1 in a vehicle. Vehicle security system 1 includes a plurality of groups into which a plurality of software areas are separated for each virtual machine or each container, and includes first communication controller A1, second communication controller A2, and third communication controller A3. First communication controller A1 manages communication related to a software area belonging to a first group of the plurality of groups. Second communication controller A2 manages communication related to the software area belonging to a second group of the plurality of groups. Third communication controller A3 manages communication between the software area belonging to the first group and the software area belonging to the second group, separately from the first communication and the second communication.

According to this, the communication related to the software area belonging to the first group is separated from the communication related to the software area belonging to the second group, so that the effects of processing in one group do not affect the processing in the other group. In addition, according to this, separately from the first communication and the second communication, communication from a software area belonging to the first group to a software area belonging to the second group is possible only via third communication controller A3. For this reason, management of communication across groups (virtual machines) within the device (integrated ECU 100) or communication across the device (integrated ECU 100) and another device (ECU 100A) is also easily expandable. That is, according to this, there is an advantage that partition separation can be also applied to an in-vehicle system including a plurality of virtual machines while suppressing operating costs.

In addition, in vehicle security system 1 according to Aspect 2, in Aspect 1, each of the first group and the second group includes a software area including communication monitor B1 as the software area. When communication monitor B1 receives a message, communication monitor B1 executes a monitoring process for monitoring whether the received message is normal.

This has the advantage that if the received message is normal, communication to the destination of the message is permitted, and if the message is anomalous, communication to the destination of the message can be rejected, making it easier to ensure the security of the software area of each of the first group and second group.

In addition, in vehicle security system 1 according to Aspect 3, in Aspect 2, when each of first communication controller A1 and second communication controller A2 receives a message, each of first communication controller A1 and second communication controller A2 executes a determination process to determine whether a destination of the received message belongs to a group to which each of the first communication controller and the second communication controller belongs, and when the destination does not belong to the group, each of the first communication controller and the second communication controller transfers the message to third communication controller A3.

This has the advantage that since each of first communication controller A1 and second communication controller A2 can manage only communication for the group to which it belongs, it is easy to suppress operational costs compared to managing communication for each of all groups.

In addition, in vehicle security system 1 according to Aspect 4, in Aspect 3, when a result of the determination process indicates that the destination of the message belongs to the group to which each of first communication controller A1 and second communication controller A2 belongs, each of first communication controller A1 and second communication controller A2 executes a decision process to decide whether to send the message directly to the destination, and when direct communication to the destination is rejected, each of first communication controller A1 and second communication controller A2 sends the message to communication monitor B1.

This has the advantage that since only a message that is permitted for direct communication can be sent to the destination of the message, it is easy to ensure the security.

In addition, in vehicle security system 1 according to Aspect 5, in Aspect 4, the software areas are logically divided into a plurality of partitions different from divisions by the plurality of groups. In the decision process, when a partition to which a sender of the message belongs and a partition to which the destination of the message belongs are different from each other, direct communication to the destination is rejected.

This has the advantage that since only communication between software areas belonging to the same partition is permitted, it is easy to ensure the security.

In addition, in vehicle security system 1 according to Aspect 6, in any one of Aspects 2 to 5, each of the first and second groups includes, as software areas, a first area, a second area, and a third area according to a degree of trustworthiness indicating a degree of possibility of being tampered with by an attacker. The degree of trustworthiness of the first area is lower than those of the second area and the third area. The degree of trustworthiness of the third area is higher than those of the first area and the second area. The second area includes communication monitor B1 that monitors communication to the third area.

This has the advantage that since only a message that is permitted for direct communication to the third area can be sent to the destination of the message, it is easy to ensure the security of the third area.

In addition, in vehicle security system 1 of Aspect 7, in any one of Aspects 1 to 6, the device including the first group (integrated ECU 100) and the device including the second group (ECU 100A) are different from each other.

This has the advantage that partition separation can be applied even to communication across a plurality of devices.

In addition, in vehicle security system 1 of Aspect 8, in Aspect 7, third communication controller A3 in the device including the first group (integrated ECU 100) and third communication controller A3 in the device including the second group (ECU 100A) manage communication between the software area belonging to the first group and the software area belonging to the second group by cooperating with each other.

This has the advantage that partition separation can be applied even to communication across a plurality of devices.

In addition, the security method according to Aspect 9 is a security method executed by vehicle security system 1 in a vehicle. Vehicle security system 1 includes a plurality of groups into which a plurality of software areas are separated for each virtual machine or each container. The vehicle security method manages communication relating to a software area belonging to a first group of the plurality of groups. The vehicle security method manages communication relating to a software area belonging to a second group of the plurality of groups. The vehicle security method manages communication between the software area belonging to the first group and the software area belonging to the second group.

According to this, the communication related to the software area belonging to the first group is separated from the communication related to the software area belonging to the second group, so that the effects of processing in one group do not affect the processing in the other group. In addition, according to this, separately from the first communication and the second communication, communication from a software area belonging to the first group to a software area belonging to the second group is performed. For this reason, management of communication across groups (virtual machines) within the device (integrated ECU 100) or communication across the device (integrated ECU 100) and another device (ECU 100A) is also easily expandable. That is, according to this, there is an advantage that partition separation can be also applied to an in-vehicle system including a plurality of virtual machines while suppressing operating costs.

In addition, the program according to Aspect 10 causes one or more processors to execute a security method according to Aspect 9.

According to this, the communication related to the software area belonging to the first group is separated from the communication related to the software area belonging to the second group, so that the effects of processing in one group do not affect the processing in the other group. In addition, according to this, separately from the first communication and the second communication, communication from a software area belonging to the first group to a software area belonging to the second group is performed. For this reason, management of communication across groups (virtual machines) within the device (integrated ECU 100) or communication across the device (integrated ECU 100) and another device (ECU 100A) is also easily expandable. That is, according to this, there is an advantage that partition separation can be also applied to an in-vehicle system including a plurality of virtual machines while suppressing operating costs.

### CROSS REFERENCE TO RELATED APPLICATIONS

The present application is based on and claims priority of Japanese Patent Application No. 2024-006620 filed on Jan. 19, 2024, and Japanese Patent Application No. 2024-059616 filed on Apr. 2, 2024.

### INDUSTRIAL APPLICABILITY

The present disclosure can be applied to in-vehicle networks and the like.

1. A vehicle security system in a vehicle, the vehicle security system comprising:
a plurality of groups into which a plurality of software areas are separated for each virtual machine or each container;
a first communication controller that manages first communication related to a software area belonging to a first group of the plurality of groups;
a second communication controller that manages second communication related to a software area belonging to a second group of the plurality of groups; and
a third controller communication that manages communication between the software area belonging to the first group and the software area belonging to the second group, separately from the first communication and the second communication.

2. The vehicle security system according to claim 1, wherein
each of the first group and the second group includes a software area including a communication monitor as the software area, and
when the communication monitor receives a message, the communication monitor executes a monitoring process for monitoring whether the message received is normal.

3. The vehicle security system according to claim 2, wherein
when a message is received, each of the first communication controller and the second communication controller executes a determination process to determine whether a destination of the message received belongs to a group to which each of the first communication controller and the second communication controller belongs, and when the destination does not belong to the group, each of the first communication controller and the second communication controller transfers the message to the third communication controller.

4. The vehicle security system according to claim 3, wherein
when a result of the determination process indicates that the destination of the message belongs to the group to which each of the first communication controller and the second communication controller belongs, each of the first communication controller and the second communication controller executes a decision process to decide whether to send the message directly to the destination, and when direct communication to the destination is rejected, each of the first communication controller and the second communication controller sends the message to the communication monitor.

5. The vehicle security system according to claim 4, wherein
the plurality of software areas are logically divided into a plurality of partitions different from divisions by the plurality of groups, and
in the decision process, when a partition to which a sender of the message belongs and a partition to which the destination of the message belongs are different from each other, direct communication to the destination is rejected.

6. The vehicle security system according to claim 2, wherein
each of the first group and the second group includes, as the plurality of software areas, a first area, a second area, and a third area according to a degree of trustworthiness indicating a degree of possibility of being tampered with by an attacker,
the degree of trustworthiness of the first area is lower than the degree of trustworthiness of the second area and the degree of trustworthiness of the third area,
the degree of trustworthiness of the third area is higher than the degree of trustworthiness of the first area and the degree of trustworthiness of the second area, and
the second area includes the communication monitor that monitors communication to the third area.

7. The vehicle security system according to claim 2, wherein
a device including the first group and a device including the second group are different from each other.

8. The vehicle security system according to claim 7, wherein
the third communication controller in the device including the first group and the third communication controller in the device including the second group manage communication between the software area belonging to the first group and the software area belonging to the second group by cooperating with each other.

9. A security method executed by a vehicle security system in a vehicle, the vehicle security system including a plurality of groups into which a plurality of software areas are separated for each virtual machine or each container, the security method comprising:
managing communication related to a software area belonging to a first group of the plurality of groups;
managing communication related to a software area belonging to a second group of the plurality of groups; and
managing communication between the software area belonging to the first group and the software area belonging to the second group.
